(19) United States
(12) Patent Application Publication
(10) Pub. No.: US 2017/0025907 A1
(43) Pub. Date: Jan. 26, 2017

(54) STATOR FOR ELECTRIC ROTARY MACHINE

(71) Applicant: HONDA MOTOR CO., LTD., Tokyo (JP)

(72) Inventor: Tomotaka Iki, Wako-shi (JP)

(73) Assignee: HONDA MOTOR CO., LTD., Tokyo (JP)

(21) Appl. No.: 15/301,006

(22) PCT Filed: Feb. 18, 2015
(86) PCT No.: PCT/JP2015/054397

§ 371 Date: Sep. 30, 2016

(30) Foreign Application Priority Data
Mar. 31, 2014 (JP) 2014-072868

(51) Int. Cl. H02K 1/16; H02K 3/32; H02K 3/50; H02K 3/12; H02K 3/28

(52) U.S. Cl. CPC H02K 1/16; H02K 3/12; H02K 3/28; H02K 3/50; H02K 3/32

(57) ABSTRACT

A stator for an electric rotary machine including a stator core and a coil, wherein: the coil has plural slot coils, each slot coil being inserted into the slot, and plural connection coils, each connection coil connecting the slot coils in a position lying further axially outwards than an axial end face of the stator core; the connection coil has an inner connection coil portion and an outer connection coil portion, the inner connection coil port on and the outer connection coil portion being disposed individually on planes that intersect an axial direction at a right angle and that lie in different axial positions, and an axial extending portion that connects the inner connection coil portion and the outer connection coil portion; and the inner connection coil portion, the outer connection coil portion, and the axial extending portion are configured by an integral conductor.

### TECHNICAL FIELD

The present invention relates to a stator for an electric rotary machine that can be mounted on an electric vehicle, a hybrid vehicle and the like.

### BACKGROUND ART

There have conventionally be known stators of electric rotary machines in which coils are prepared by winding winding wires around teeth of a stator core. In the conventional electric rotary machines in which the coils are prepared by winding the winding wires around the teeth of a stator core, since the winding wires and the stator core need to be handled separately and the winding wire are wound around the teeth with insulation paper held therebetween, the winding operation becomes complex, and since the insulation paper is bitten into, there are fears that an appropriate insulation performance cannot be ensured.

Then, in recent years, electric rotary machines have been proposed which employ segment coils as a different type of electric rotary machine stator. For example, in a stator for an electric rotary machine described in Patent Literature 1, connection coils are joined to both end portions of slot coils that are inserted in slots in a stator core to connect slot coils of the same phase, and inner connection coils and outer connection coils that make up the connection coils are joined together by pins.

### PRIOR ART LITERATURE

### Patent Literature

Patent Literature 1: JP-B-5389109

### SUMMARY OF THE INVENTION

### Problem that the Invention is to Solve

In the stator for an electric rotary machine described in Patent Literature 1, however, since the inner connection coils and the outer connection coils are configured as separate members, a fabrication step is necessary of joining the inner connection coils and the outer connection coils and the pins together.

The invention provides a stator for an electric rotary machine that can reduce the number of parts involved and which can simplify a fabrication process.

### Means for Solving the Problem

The invention provides the following Aspects.

Aspect 1 defines a stator (e.g., a stator 210 in embodiment) for an electric rotary machine including:

a stator core (e.g., stator core 221 in embodiment), which has plural slots (e.g., slots 223 in embodiment); and

a coil (e.g., a coil 250 in embodiment), which is attached to the stator core, wherein:

the coil has plural slot coils (e.g., radially outer slot coil portions 226, radially inner slot coil portions 227 in embodiment), each slot coil being inserted into the slot, and plural connection coils (e.g., connection coils 240 in embodiment), each connection coil connecting the slot coils in a position lying further axially outwards than an axial end face (e.g., an end face 221a, 221b in embodiment) of the stator core;

the connection coil has an inner connection coil portion (e.g., an inner connection coil portion 242 in embodiment) and an outer connection coil portion (e.g., an outer connection coil portion 241 in embodiment), the inner connection coil portion and the outer connection coil portion being disposed individually on planes that intersect an axial direction at a right angle and that lie in different axial positions, and an axial extending portion (e.g., an axial extending portion 2-14 in embodiment) that connects the inner connection coil portion and the outer connection coil portion; and

the inner connection coil portion, the outer connection coil portion, and the axial extending portion are configured by an integral conductor.

Aspect 2 defines, based on Aspect 1, the stator for an electric rotary machine, wherein:

the inner connection coil portion, the outer connection coil portion, and the axial extending portion are made up of an integral plate conductor; and

when seen from the axial direction, the inner connection coil portion and the outer connection coil portion extend in different directions.

Aspect 3 defines, based on Aspect 1 and Aspect 2, the stator for an electric rotary machine, wherein

a slot coil portion that makes up the slot coil is thither connected to at least one of the inner connection coil portion and the outer connection coil portion as the integral conductor.

Aspect 4 defies, based on any one of Aspect 1 to Aspect 3, the stator for an electric rotary machine, wherein:

the stator further includes an insulation plate portion (e.g., a base plate portion 231L, 231R in embodiment) that are molded integrally with the connection coils; and

the insulation plate portion has a partition wall portion, which is situated between the inner connection coil portion and the outer connection coil portion that are spaced away from each other in the axial direction, and a wall portion, which is situated between the connection coils that lie adjacent to each other.

Aspect 5 defines, based on any one of Aspect 1 to Aspect 4, the stator for an electric rotary machine, wherein:

the connection coil includes: a first connection coil (e.g., a first connection coil 240L in embodiment) that connects the plural slot coils together in a position lying further axially outwards than one axial end face of the stator core; and a second connection coil (e.g., a second connection coil 240R in embodiment) that connects the plural slot coils together in a position lying further axially outwards than an other axial end face of the stator core;

the first connection coil has: a first inner connection coil portion (e.g., an inner connection coil portion 242 in embodiment) and a first outer connection coil portion (e.g., an outer connection coil portion 241 in embodiment), which are disposed individually on planes that intersect the axial direction at a right angle and that lie in different axial positions; and a first axial extending portion (e.g., an axial extending portion 244 in embodiment), which connects the first inner connection coil portion and the first outer connection coil portion;

the second connection coil has: a second inner connection coil portion (e.g., an inner connection coil portion 242 in embodiment) and a second outer connection coil portion (e.g., an outer connection coil portion 241 in embodiment), which are disposed individually on planes that intersect the axial direction at a right angle and that lie in different axial positions; and a second axial extending portion (e.g., an axial extending portion 244 in embodiment), which connects the second inner connection coil portion and the second outer connection coil portion;

the first inner connection coil portion, the first outer connection coil portion, and the first axial extending portion are configured by an integral conductor; and

the second inner connection coil portion, the second outer connection coil portion, and the second axial extending portion are configured by an integral conductor.

Aspect 6 defines, based on Aspect 5, the stator for an electric rotary machine, wherein:

the stator further includes: a first insulation plate portion (e.g., a base plate portion 231L in embodiment), which is molded integrally with the first connection coil; and a second insulation plate portion (e.g., a base plate portion 231R in embodiment), which is molded integrally with the second connection coil;

the first insulation plate portion includes: a partition wall portion, which is situated between the first inner connection coil portion and the first outer connection coil portion that are spaced away from each other in the axial direction; and a wall portion, which is situated between the first connection coils that lie adjacent to each other;

the second insulation plate portion includes: a partition wall portion, which is situated between the second inner connection coil portion and the second outer connection coil portion that are spaced away from each other in the axial direction; and a wall portion, which is situated between the second connection coils that lie adjacent to each other;

in the first connection coil, a slot coil portion (e.g., a radially outer slot coil portion 226, a radially inner slot coil portion 227 in embodiment) that makes up the slot coil is further connected to at least one of the first inner connection coil portion and the first outer connection coil portion as the integral conductor; and

a slot insulating portion a slot insulating portion 228 in embodiment) that covers an outer circumference of the slot coil portion is configured integrally with the first insulation plate portion.

### Advantage of the Invention

According to Aspect 1, the inner connection coil portion, the outer connection coil portion, and the axial extending portion are made up of the integral conductor, whereby the connection coil that connects the slot coils together can be made up of the one part. Consequently, not only can the number of constituent parts of the connection coil be reduced, but also the number of joining steps in the fabrication process of the connection coil can be reduced.

According to Aspect 2, the inner connection coil portion, the outer connection coil portion, and the axial extending portion are formed of the integral plate conductor through press forming as an example, and the inner connection coil portion and the outer connection coil portion can be formed so as to extend in the desired directions through bend forming. Thus, the connection coil can easily be formed into the shape for connecting the slot coils that are disposed in the slots that he in the different circumferential position while making up the connection coil using the single part.

According to Aspect 3, since the slot coil and the connection coil that connects the slot coils can be made up of the one part, not only can the number of constituent parts of the coil be reduced, but also a joining step of joining the slot coil and the connection coil together can be eliminated.

According to Aspect 4, the insulation between the inner connection coil portion and the outer connection coil portion and the insulation between the adjacent connection coils can be realized by the insulation plate portion that is molded integrally with the connection coil.

According to Aspect 5, in each of the first and second connection coils at the axial ends, since the connection coil that connects the slot coils can be made up of the one part, not only can the number of constituent parts of the connection coil be reduced, but also a joining step in the fabrication process of the connection coil can be eliminated.

According to Aspect 6, since the slot coil and the connection coil that connects the slot coils can be made up of the one part, not only can the number of constituent parts of the coil be reduced further, but also a joining step of joining the slot coil and the connection coil together can be eliminated. In addition, the insulation between the slot coil portion and the stator core can also be realized by the slot insulating portion that is formed integrally with the first insulation plate portion.

### BRIEF DESCRIPTION OF DRAWINGS

FIG. 1 is a perspective view of a stator for an electric rotary machine according to a reference example of the invention.

FIG. 2 is an exploded perspective view of the stator shown in FIG. 1.

FIG. 3 is an exploded perspective view of one of base plate assemblies shown in FIG. 2.

FIG. 4 is an exploded perspective view of the other of the base plate assemblies shown in FIG. 2.

FIG. 5A is a perspective view of a slot coil that is incorporated in a stator core assembly shown in FIG. 1.

FIG. 5B is an exploded perspective view of the slot coil.

FIG. 6 is a vertical sectional view showing part of the stator shown in FIG. 1.

FIG. 7A is a front view showing part of the base plate assemblies shown in FIGS. 3 and 4.

FIG. 7B is a front view showing part of the base plate assembly shown in FIG. 4.

FIG. 8 is a perspective view of coils of a plurality of phases that are taken out of the stator in FIG. 1.

FIG. 9 is a front view of FIG. 8.

FIG. 10 is a perspective view of a coil of one phase that is taken out of the coils of the plurality of phases shown in FIG. 8.

FIG. 11 is a development view of a U-phase coil in the stator shown in FIG. 1.

FIG. 12 is a schematic view showing connections of U-phase, V-phase and W-phase coils.

FIG. 13 is a perspective view illustrating the joining of an outer connection coil extending portion and an inner connection coil extending portion in the stator core shown in FIG. 1.

FIG. 14 is a perspective view illustrating the joining of a radially inner end portion of the outer connection coil and a step portion of a radially outer slot coil and the joining of a radially inner end portion of the inner connection coil and a step portion of a radially inner slot coil in the stator shown in FIG. 1.

FIG. 15 is a perspective view of a stator for an electric rotary machine according to an embodiment of the invention.

FIG. 16 is an exploded perspective view of the stator shown in FIG. 15.

FIG. 17 is a perspective view of the stator shown in FIG. 15 with a mold resin removed from the stator.

FIG. 18 is an explanatory diagram illustrating a molding method and an aligning method of first connection coils.

FIG. 19 shows explanatory diagrams illustrating a molding method of a first molded body

FIG. 20 shows explanatory diagrams illustrating a molding method and an aligning method of second connection coils and a molding method of a second molded body.

FIG. 21 is a partial enlarged view of FIG. 17.

FIG. 22A is a plan view showing a sheet material before first connection coils are pressed.

FIG. 22B is a plan view showing a sheet material before second connection coils are pressed.

### MODE FOR CARRYING OUT THE INVENTION

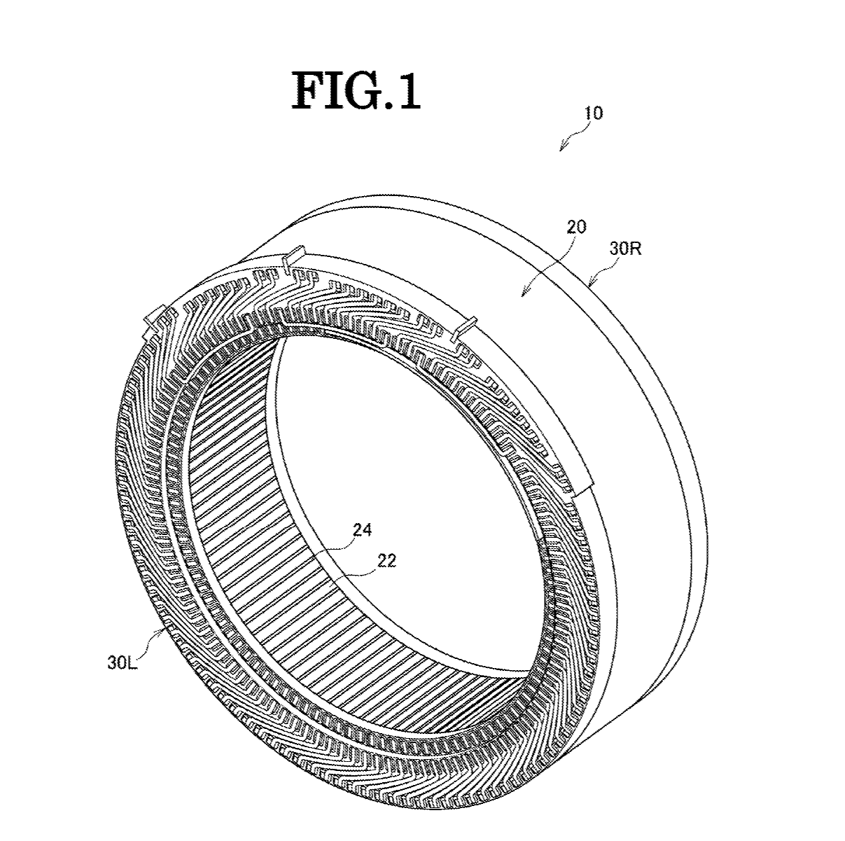

At the beginning, a stator for an electric rotary machine according to a reference example of the invention will be described based on FIGS. 1 to 14 before describing a stator for an electric rotary machine of the invention. The drawings should be seen in a direction in which reference numerals given therein look proper.

### [1 Stator]

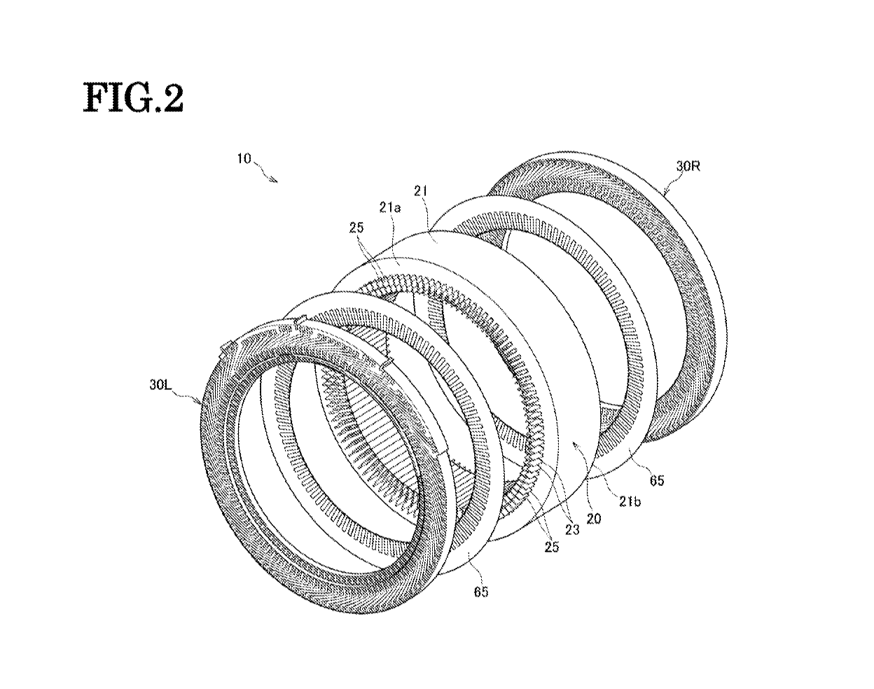

As shown in FIGS. 1 and 2, a stator 10 for an electric rotary machine of the reference example includes a stator core assembly 20 and a pair of base plate assemblies 30L, 30R, and the base plate assemblies 30L, 30R are disposed at both ends of the stator core assembly 20. An insulation sheet 65 of, for example, a silicone sheet is disposed between the stator core assembly 20 and each of the base plate assemblies 30L, 30R to insulate the stator core assembly 20 from the base plate assemblies 30L, 30R.

### [1-1 Stator Core Assembly]

The stator core assembly 20 includes a stator core 21 and plural (108 in the the reference example) slot coils 25,

### [1-1-1 Stator Core]

The stator core 21 is made up, for example, of plural pressed and punched sheets of silicon steel that are laminated together and includes plural (108 in the reference example) teeth 22 and plural (108 in the reference example) slots 23 that are defined between the adjacent teeth 22 on a radially inner side thereof. The slots 23 are formed so as to penetrate the stator core 21 in an axial direction thereof, are each formed into a substantially elliptic shape that is long in a radial direction of the stator core 21 as seen in the axial direction and each has an opening portion 24 that opens to an inner circumferential surface of the stator core 21.

### [1-1-2 Slot Coil]

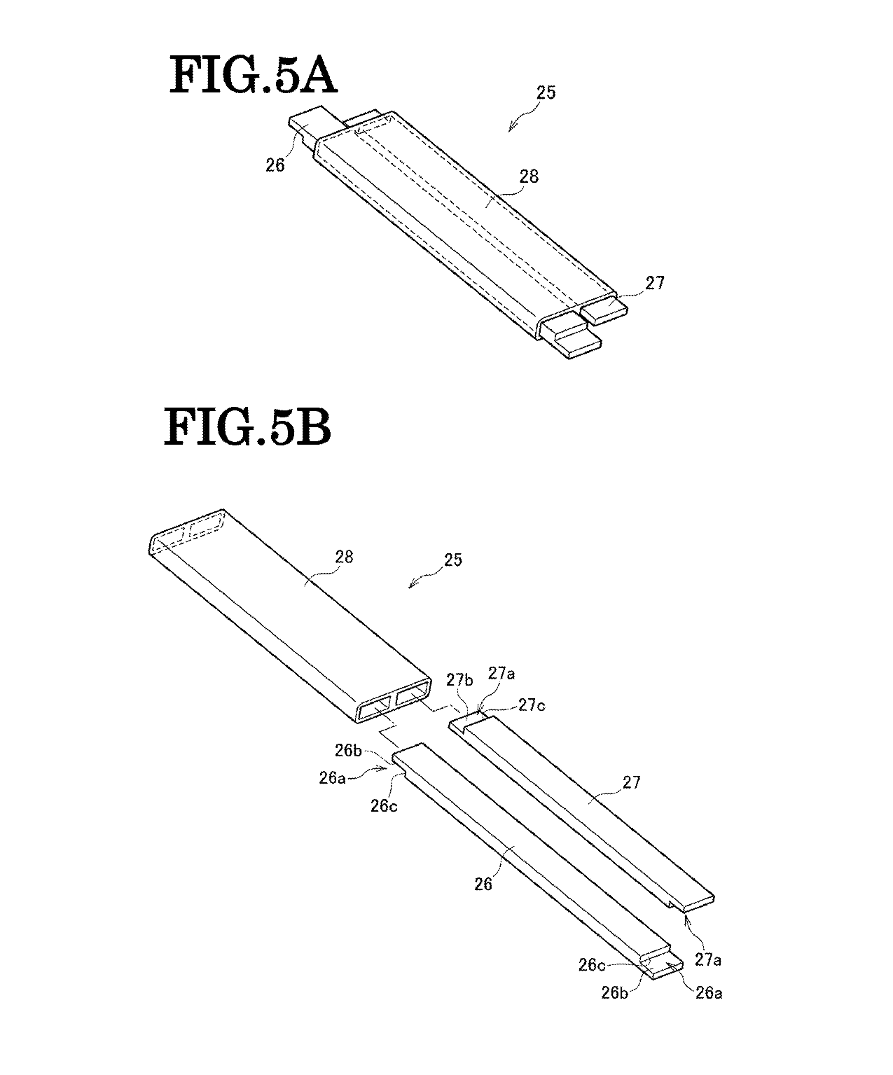

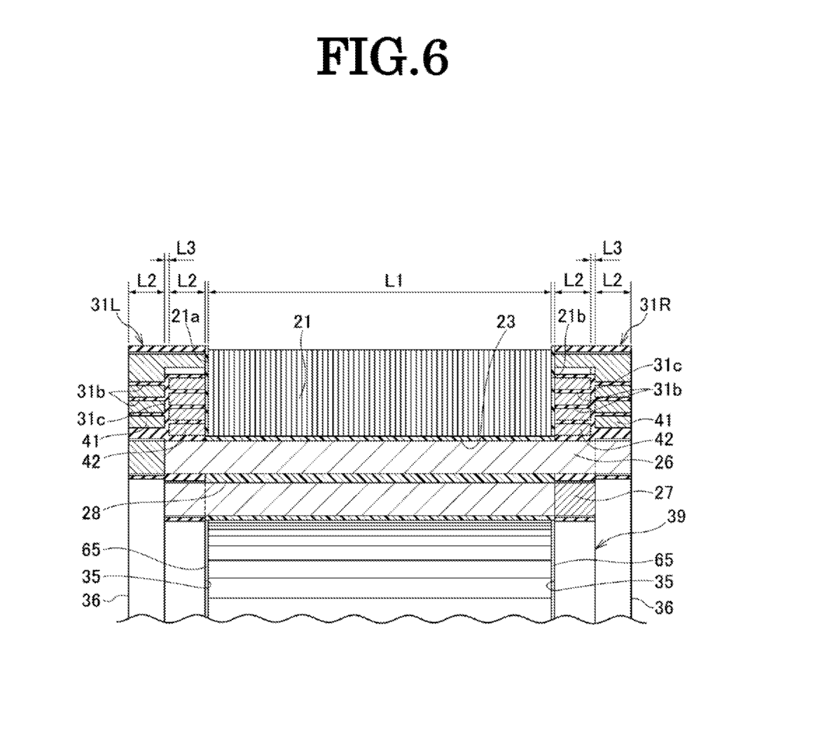

Referring also to FIGS. 5A, 5B and 6, the slot coil 25 inserted into each slot 23 has a radially outer slot coil 26 and a radially inner slot coil 27 which are both a plate conductor having a rectangular section, and the radially outer slot coil 26 and the radially inner slot coil 27 are surrounded therearound excluding axial end portions thereof by an insulation material 28 having a rectangular section which is an injection molded resin, whereby the radially outer slot coil 26 and the radially inner slot coil 27 are formed into an integral unit. Specifically speaking, the radially outer slot coil 26 is set at a length (L1+4×L2) that is substantially equal to a sum of an axial width L1 of the stator core 21 and a total axial width (4×L2) of four connection coils 40, which will be described later, and axial end portions are exposed individually from the insulation material 28 by a length (2×L2) substantially equaling a total axial width of two connection coils 40. Further, at one axial end portion of the radially outer slot coil 26, a surface oriented in one circumferential direction is cut out by a length (L2) equalling the axial width of one connection coil 40 in a step-like fashion so as to reduce a thickness of the one axial end portion, whereby a step portion 26a is formed on the one axial end portion, while at the other axial end portion of the radially outer slot coil 26, a surface oriented in the other circumferential direction is cut out by the length (L2) equalling the axial width of one connection coil 40 in a step-like fashion so as to reduce a thickness of the other axial end portion, whereby a step portion 26a is formed on the other axial end portion.

The radially inner slot coil 27 is set at a length (L1÷2×L2) that is substantially equal to a sum of the axial width (L1) of the stator core 21 and a total axial width (2×L2) of two connection coils 40, which will be described later, and axial end portions are exposed individually from the insulation material 28 by the length (L2) substantially equaling an axial width of one connection coil 40. Further, at one axial end portion of the radially inner slot coil 27, a surface oriented in the other circumferential direction is cut out by a length (L2) equalling the axial width of one connection coil 40 in a step-like fashion so as to reduce a thickness of the one axial end portion, whereby a step portion 27a is formed on the one axial end portion, while at the other axial end portion of the radially inner slot coil 27, a surface oriented in the one circumferential direction is cut out by the length (L2) equalling the axial width of one connection coil 40 in a step-like fashion so as to reduce a thickness of the other axial end portion, whereby a step portion 27a is formed on the other axial end portion.

In other words, in the slot coil 25, the radially outer slot coil 26 is exposed from the insulation material 28 at the axial ends thereof by the length (2×L2) substantially equalling the total axial width of two connection coils 40, and the radially inner slot coil 27 is exposed from the insulation material 28 at the axial ends thereof by the length (L2) equalling the axial width of one connection coil 40. The step portions 26a, 27a are formed at the distal end portions of the radially outer slot coil 26 and the radially inner slot coil 27 by the length (L2) equalling the axial width of one connection coil 40 so as to be oriented in the opposite circumferential directions. In addition, the step portions 26a of the radially outer slot coil 26 and the step portions 27a of the radially inner slot coil 27 are formed so as to be oriented in the opposite circumferential directions at the one axial end portion and the other axial end portion.

The plural (108 in the reference example) slot coils 25 each made up of the radially outer slot coil 26 and the radially inner slot coil 27 are disposed along the radial directions of the stator core 21 so that the radially outer slot coils 26 are situated on a radially outer side and the radially inner slot coils 27 are situated on a radially inner side. The slot coils 25 are inserted individually into the plural slots 23 formed in the stator core 21 and are aligned in the circumferential direction of the stator core 21, thereby making up the stator core assembly 20.

The radially outer slot coil 26 is inserted into the slot 23 so that the distal end portions project individually from both end faces 21a, 21b of the stator core 21 by the distance (2×L2) that is substantially equal to the total axial width of substantially two connection coils 40, and the radially inner slot coil 27 is inserted into the slot 23 so that the distal end portions project individually from both the end faces 21a, 21b of the stator core 21 by the length (L2) that is equal to the axial width of substantially one connection coil 40.

The insulation material 28 that covers the radially outer slot coil 26 and the radially inner slot coil 27 is interposed between both the slot coils 26, 27 and the slot 23 in the stator core 21 so as to ensure the insulation between the radially outer and inner slot coils 26, 27 and the stator core 21.

The insulation material 28 that covers the radially outer slot coil 26 and the radially inner slot coil 27 has substantially the same shape as that of the slot 23 but is slightly greater than the slot 23, and the insulation material 28 can easily be fixed into the slot 23 through press fitting. Since the radially outer slot coil 26 and the radially inner slot coil 27 are thicker than the conventional coils that are made up of the winding wires wound around the teeth, the space factor of the slot 23 is advantageously improved.

### [1-2 Base Plate Assembly]

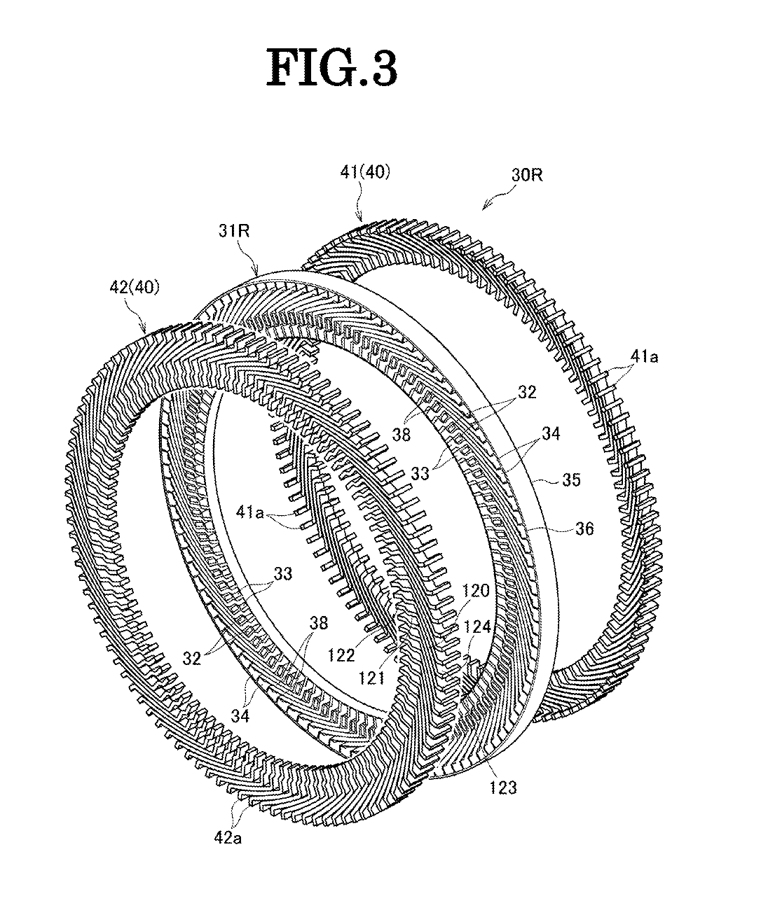

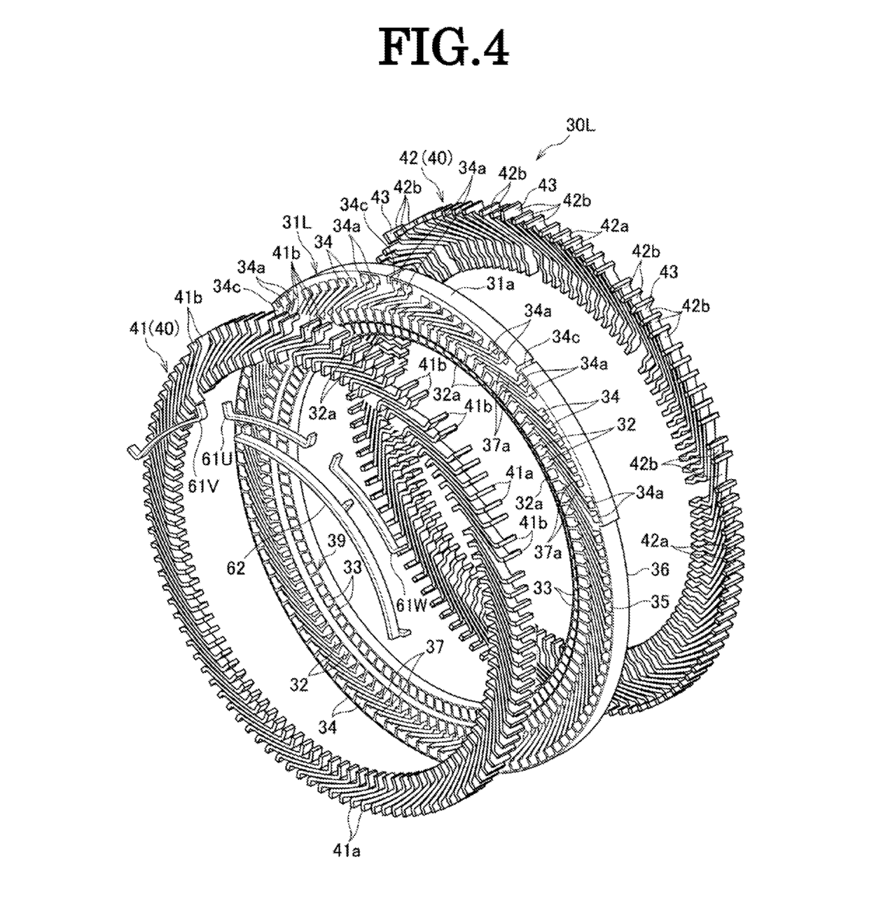

The base plate assemblies 30L, 30R that are disposed individually at the ends of the stator core assembly 20 include base plates 31L, 31R and plural connection coils 40, as shown in FIGS. 3 and 4.

### [1-2-1 Base Plates]

The base plates 31L, 31R are substantially annular members that are formed from sin having insulation properties (a non-magnetic material) and which have a bore diameter and an outside diameter that are substantially the same as those of the stator core 21.

As shown in FIG. 3, a plurality (108 in the reference example) of radially outer through holes 32 and a plurality (108 in the reference example) of radially inner through holes 33 are formed at equal intervals in a radially inner side of the base plate 31R so as to correspond to the radially outer slot coils 26 and the radially inner slot coils 27, respectively, of the slot coils 25 that are inserted into the slots 23 in the stator core 21. The radially outer through holes 32 and the radially inner through holes 33 penetrate the base plate 31R to establish a communication between an outer surface 35 and an inner surface 36 of the base plate 31R. By assembling the base plate assembly 30R to the stator core assembly 20, the distal end portions of the radially outer slot coils 26 that are inserted into the slots 23 in the stator core 21 and which project from the end faces 21b of the stator core 21 are disposed in the radially outer through holes 32 of the base plate 31R and the distal end portions of the radially inner slot coils 27 that are inserted into the slots 23 in the stator core 21 and which project from the end faces 21b of the stator core 21 are disposed in the radially inner through holes 33 of the base plate 31R. In the radially outer through holes 32, opening portions that open to the inner surface 36 are smaller than opening portions that open to the outer surface 35, and are caused to penetrate the base plate 31R at only portions where the distal end portions of the radially outer slot coils 26 pass through.

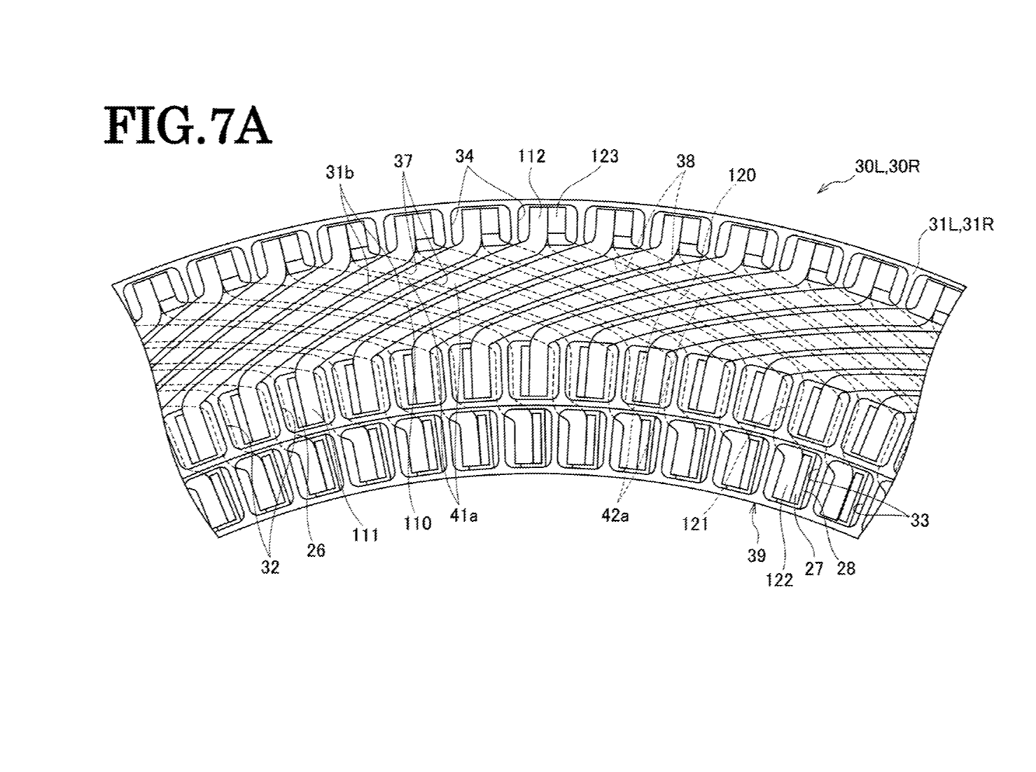

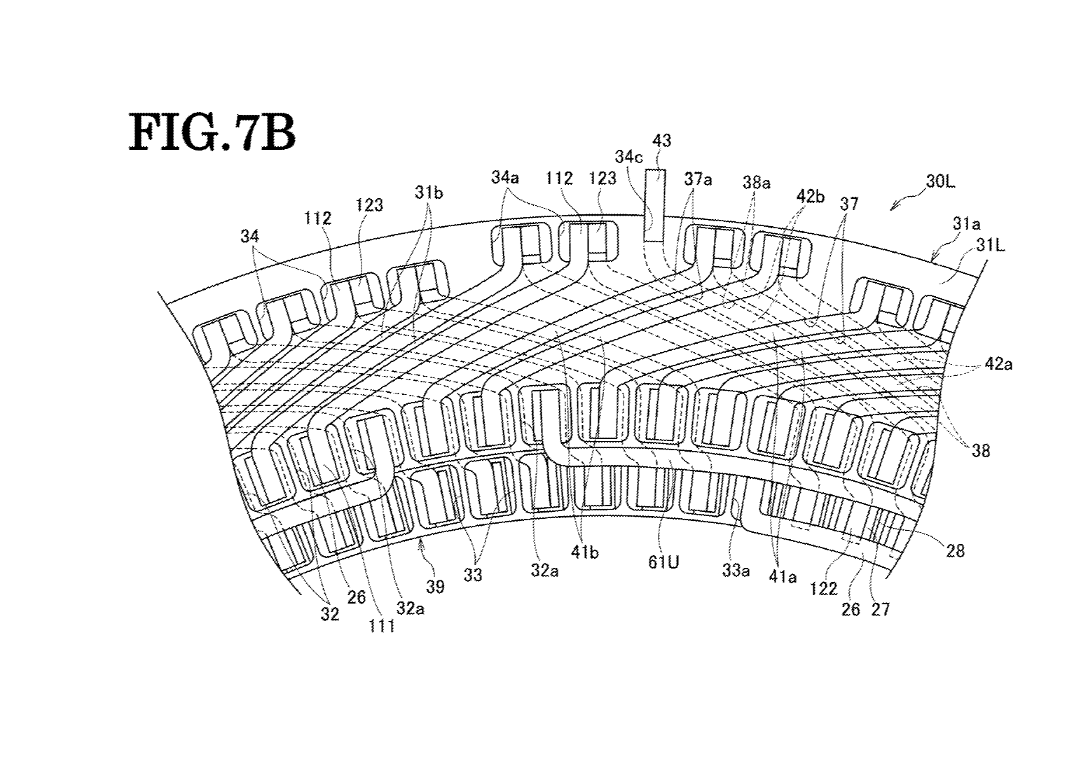

Further, a plurality (108 in the reference example) of outer circumferential holes 34 are formed at equal intervals in a radially outer side of the base plate 31R so as to penetrate the base plate 31R, whereby a communication is established between the outer surface 35 and the inner surface 36. As shown in FIG. 7A, a plurality (108 in the reference example) of outer surface grooves 37 and a plurality (108 in the reference example) of inner surface grooves 38 are formed on the outer surface 35 and the inner surface 36 of the base plate 31R, respectively, so as to extend in circumferential directions along involute curves in such a way as to lie close to one another. The outer surface grooves 37 and the inner surface grooves 38 have a substantially U-shaped cross section and open to the outer surface 35 and the inner surface 36, respectively,

The base plate 31L basically has a similar construction to that of the base plate 31R. A plurality (108 in the reference example) of radially outer through holes 32 and a plurality (108 in the reference example) of radially inner through holes 33 are also formed at equal intervals in a radially inner side of the base plate 31L so as to correspond to the radially outer slot coils 26 and the radially inner slot coils 27, respectively, of the slot coils 25 that are inserted into the slots 23 in the stator core 21. The radially outer through holes 32 and the radially inner through holes 33 penetrate the base plate 31L so as to establish a communication between the outer surface 35 and the inner surface 36 of the base plate 31R.

On the other hand, a deployed portion 31a that extends into a fan shape is provided on a radially outer side of an upper portion in the figure on a radially outer side of the base plate 31L, and plural outer circumferential holes 34 are formed at equal intervals in other portions than the deployed portion 31a so as to penetrate the base plate 31L to thereby establish a communication between the outer surface 35 and the inner surface 36. In the deployed portion 31a, two sets of two outer circumferential holes 34a, each having an opening area that is slightly greater than that of the other outer circumferential holes 34, are formed for each of U, V and W phases in such a way as to hold six outer circumferential holes 34 therebetween, and input terminal notched portions 34c are formed at equal intervals one for each phase. Input terminal portions 43 of three inner connection coils 42b with which the input terminal portions 43 are formed integrally are disposed individually in the input terminal notched portions 34c. The inner connection coils 42b will be described later.

On a radially inner side of the deployed portion 31a of the base plate 31L, a set of two radially outer through holes 32a, each having a busbar notched portion (not shown) formed on an inner circumferential side thereof are formed for each phase in such a way as to hold eight radially outer through holes 32 therebetween. Further, radially inner through hole 33a having a middle point busbar notched portion (not shown) formed on an inner circumferential side thereof are formed for each phase in such a way as to hold eleven radially inner through holes 33 therebetween. Busbar connecting portions of busbars 61U, 61V, 61W that connect coils of the same phase together are disposed in the busbar notched portions, and middle point busbar connecting portions of middle point busbars 62 that connect coils of U, V, W phases together are disposed in the middle point busbar notched portions.

Radially outer end portions 112 of outer connection coils 41 and radially outer end portions 123 of inner connection coils 42, which will be described later, are disposed in the outer circumferential holes 34, 34a of the base plates 31L, 31R. The radially outer through holes 32, 32a, the radially inner through holes 33, 33a and the outer circumferential holes 34, 34a exhibit a rectangular shape as seen from the axial direction and have a space greater than the coil member (the radially outer slot coil 26, the radially inner slot coil 27, the outer connection coil 41) that is disposed in an interior thereof.

In addition, a plurality (102 in the outer surface 35 in this reference example) of outer surface grooves 37 and a plurality (102 in the inner surface 36 in this reference example) of inner surface grooves 38 are formed also on the outer surface 35 and the inner surface 36 of the base plate 31L, respectively, so as to extend in circumferential directions along involute curves in such a way as to lie close to one another. The outer surface grooves 37 and the inner surface grooves 38 have a substantially U-shaped cross section and open to the outer surface 35 and the inner surface 36, respectively. In the deployed portion 31a of the base plate 31L, a total of twelve, four for each phase, outer surface grooves 37a that are formed slightly longer than the other outer surface grooves 37 are formed on the outer surface 35, and a total of fifteen, five for each phase, inner surface grooves 38a that are formed slightly longer than the other inner surface grooves 38 are formed on the inner surface 36. The number of outer surface grooves 37, 37a is smaller by six, two for each phase, than the number of outer surface grooves 37 that are formed on the base plate 31R, and the number of inner surface grooves 38, 38a is smaller by three, one for each phase, than the number of inner surface grooves 38 that are formed on the base plate 31R. In stead, the coils of the same phases are connected together by the busbars 61U, 61V, 61W and the coils of different phases are connected together by the middle point busbars 62. In these base plates 31L, 31R, as shown in FIG. 6, the outer surface grooves 37, 37a that lie adjacent to one another and the inner surface grooves 38, 38a that lie adjacent to one another are isolated by walls 31b that rise from the base plate 31L, and the outer surface grooves 37, 37a and the inner surface grooves 38, 38a that face each other in the axial direction are isolated by partition walls 31c, whereby the individual grooves are electrically insulated from one another.

In the base plates 31L, 31R, a radially innermost portion 39 where the radially inner through holes 33 are formed is set at a length (L2) that is equal to an axial width of one connection coil 40, and the other area than the radially innermost portion 39 where the radially outer through holes 32 and the outer circumferential holes 34 are formed is set at an axial width (2×L2+L3) that is substantially equal to a sum of a total axial width (2×L2) of two connection coils 40 and a thickness (L3) of the partition wall 31c.

In the base plate assemblies 30L, 30R, as shown in FIG. 7A, each of the outer surface grooves 37 of the base plates 31L, 31R is formed to be curved along the involute curve so as to connect the outer circumferential hole 34 and the radially outer through hole 32 that is spaced a predetermined angle in a counterclockwise direction from the outer circumferential hole 34, when seen from the front. As shown in FIG. 7B, however, in the plural outer surface grooves 37 on the base plate 31L, each of the twelve outer surface grooves 37a that extends towards the deployed portion 31a is formed to be curved along the involute curve so as to connect the outer circumferential hole 34a and the radially outer through hole 32 that is spaced an angle that is slightly greater than the predetermined angle in the counterclockwise direction from the outer circumferential hole 34a. FIGS. 7A, 7B show a state in which the outer connection coils 41 and the inner connection coils 42 described later are accommodated in the outer surface grooves 37 and the inner surface grooves 38, respectively.

Each of the inner surface grooves 38 of the base plates 31L, 31R is formed to be curved while avoiding the radially outer through hole 32 so as to connect the outer circumferential hole 34 and the radially inner through hole 33 that are spaced a predetermined angle in the counterclockwise direction (in a clockwise direction as seen from the side shown in FIG. 7A) from the outer circumferential hole 34, when seen from the front. As shown in FIG. 7B, however, in the plural inner surface grooves 38 on the base plate 31L, each of the twelve inner surface grooves 38a that extends towards the deployed portion 31a of the base plate 31L is formed to be curved along the involute curve so as to connect the outer circumferential hole 34a and the radially inner through hole 33 that is spaced an angle that is slightly greater than the predetermined angle in the counterclockwise direction from the outer circumferential hole 34a. The remaining three inner surface grooves 38a in the fifteen inner surface grooves 38a communicate with the input terminal notched portions 34c.

Namely, as shown in FIG. 7, the radially outer through holes 32 and the radially inner through holes 33 are connected via the outer circumferential holes 34 to which the outer surface grooves 37 and the inner surface grooves 38 continue commonly or the outer circumferential holes 34a to which the outer surface grooves 37a, and the inner surface grooves 38a continue commonly.

### [1-2-2 Connection Coils]

The connection coils 40 are formed of a conductive material such as copper into a plate shape and include the outer connection coils 41 (41a, 41b) that are inserted individually into the outer surface grooves 37, 37a and the inner connection coils 42 (42a, 42b) that are inserted individually into the inner surface grooves 38. When referred to herein, the outer connection coils 41 mean the connection coils 40 that come to lie on an axially outer side of the stator 10 and the inner connection coils 42 mean the connection coils 40 that come to lie on an axially inner side of the stator core. 10 when the stator core assembly 20 and the base plate assemblies 30L, 30R are assembled together.

The outer connection coil 41a is a plate conductor having a uniform thickness and a rectangular cross section. A radially inner end portion 111 is bent radially from an outer connection coil main body 110 that is formed so as to extend along an involute curve having the same shape as that of the outer surface groove 37, and a radially outer end portion 112 is also bent radially from the outer connection coil main body 110. An outer connection coil extending portion 113 is formed at the radially outer end portion 112 of the outer connection coil 41a so as to extend axially inwards. Axial widths (L2) of the outer connection coil main body 110 and the radially inner end portion 111 are equal to a depth of the outer surface groove 37, and an axial width of the outer connection coil extending portion 113 is set at an axial width (2×L2÷L3) that is equal to a sum of the depths of the outer surface groove 37 and the inner surface groove 38 and a thickness (L3) of the partition wall 31c. In addition, the twelve outer connection coils 41b have the same construction as that of the outer connection coil 41a except that an outer connection coil main body 110 is formed so as to be curved into the same shape as that of the outer surface groove 37a.

The inner connection coil 42a is a plate conductor having a uniform thickness and a rectangular cross section. A radially inner end portion 122 is bent radially from an inner connection coil main body 120 that is fanned so as to extend along an involute curve having the same shape as that of the inner surface groove 38 by way of a bypass portion 121 that is formed so as to bypass the radially outer through hole 32, and a radially outer end portion 123 is also bent radially from the inner connection coil main body 120. An inner connection coil extending portion 124 is formed at the radially outer end portion 123 of the inner connection coil 42a so as to extend axially outwards. Axial widths (L2) of the inner connection coil main body 120 and the radially inner end portion 122 are equal to a depth of the inner surface groove 38, and an axial width of the inner connection coil extending portion 124 is set at an axial width (2×L2+L3) that is equal to a sum of the depths of the outer surface groove 37 and the inner surface groove 38 and the thickness (L3) of the partition wall 31c. In addition, the fifteen inner connection coils 42b that are inserted into the inner surface grooves 38a basically have the same configuration as that of the inner connection coil 42a except that the inner connection coil main body 120 is formed so as to be curved into the same shape as that of the inner surface groove 38a. However, in the fifteen inner connection coils 42b, the input terminal portions 43 configured for connection to external equipment are formed integrally on the radially outer end portions 123 so as to fit in the input terminal notched portions 34c on the three inner connection coils 42b that are disposed in the positions corresponding to the input terminal notched portions 34c.

The outer connection coil 41 and the inner connection coil 42 have the same thickness, and the thickness of the outer connection coil 41 and the inner connection coil 42 is set at a thickness that is the same as the thickness of the radially outer slot coil 26 and the radially inner slot coil 27 which have the same thickness. The thickness of the outer connection coil 41 and the inner connection coil 42 is smaller than the axial width (L2) of the outer connection coil 41 and the inner connection coil 42 (the outer connection coil main body 110 and the inner connection coil main body 120). The aforesaid “the axial width of x connection coils 40 (x=1, 2, 4)” means the axial width of the outer connection coil main body 110 and the inner connection coil main body 120. “Substantially equal” represents an expression including an error equaling the thickness of the partition wall 31c. The thickness of the insulation sheet 65 is not taken into consideration.

The outer connection coils 41, the inner connection coils 42 and the slot coils 25 can be formed into the desired axial widths and desired planar shapes by pressing and punching a metallic sheet (for example, a copper sheet) having a predetermined thickness. Further, in the outer connection coil 41, by bending the pressed and punched sheet conductor, the outer connection coil main body 110 that is formed to extend along the involute curve having the same shape as that of the outer surface grooves 37, 37a, the radially inner end portion 111 and the radially outer end portion 112 that are connected from the outer connection coil main body 110 while being bent can be formed. Similarly, in the inner connection coil 42, by bending the pressed and punched sheet conductor, the inner connection coil main body 120 that is formed to extend along the involute curve having the same shape as that of the inner surface grooves 38, 38a, the radially inner end portion 122 and the radially outer end portion 123 that are connected from the inner connection coil main body 120 while being bent can be formed.

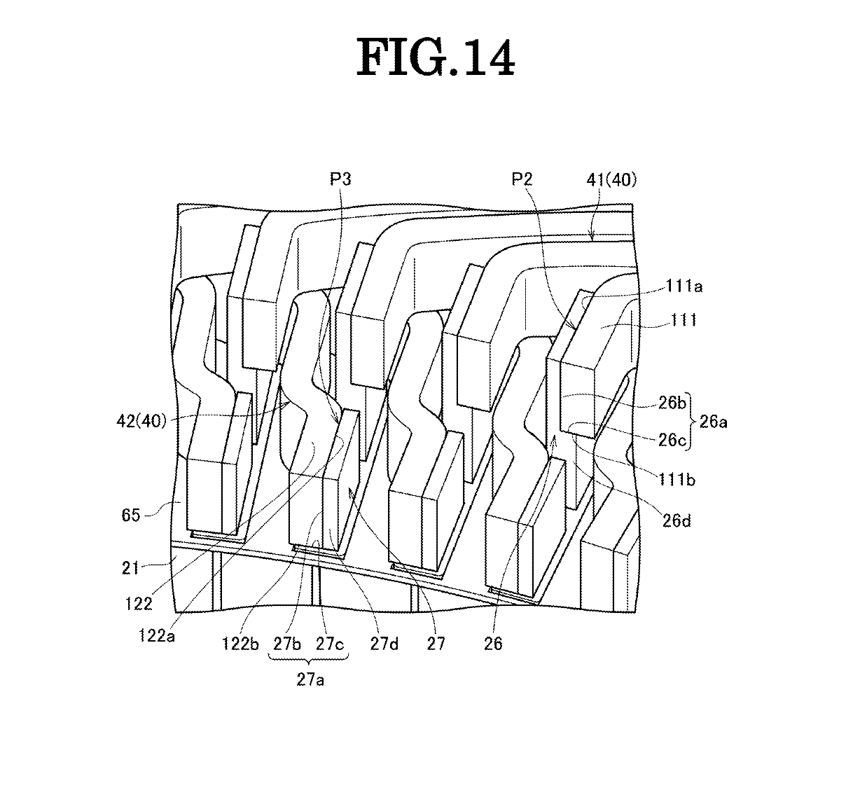

The outer connection coils 41a, 41b are inserted into the outer surface grooves 37, 37a of the base plates 31L, 31R. The radially inner end portions 111 of the outer connection coils 41 are disposed in the radially outer through holes 32 and are brought into abutment with the step portions 26a of the radially outer slot coils 26 that are inserted into the slots 23 in the stator core 21 and that are similarly disposed in the radially outer through holes 32 when assembling the stator core assembly 20 and the base plate assemblies 30L, 30R together, as shown in FIG. 14.

The inner connection coils 42a, 42b are inserted into the inner surface grooves 38, 38a of the base plates 31L, 31R. The radially inner end portions 122 of the inner connection coils 42a, 42b are disposed in the radially inner through holes 33 and are brought into abutment with the step portions 27a of the radially inner slot coils 27 that are inserted into the slots 23 in the stator core 21 and that are similarly disposed in the radially inner through holes 33 when assembling the stator core assembly 20 and the base plate assemblies 30L, 30R together, as shown in FIG. 14.

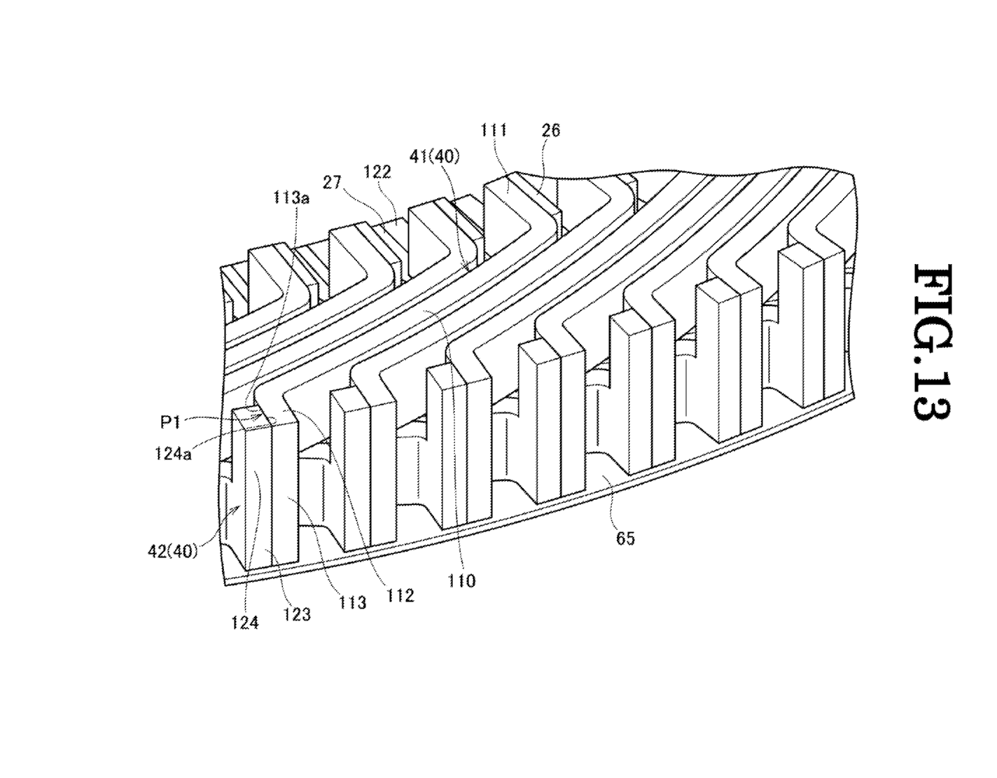

The radially outer end portions 112 of the outer connection coils 41a, 41b and the radially outer end portions 123 of the inner connection coils 42a, 42b are both disposed in the outer circumferential holes 34, whereby side surfaces 113a of the outer connection coil extending portions 113 that are oriented in the one circumferential direction and the side surfaces 124a of the inner coil extending portions 124 that are oriented in the other circumferential direction are brought into abutment with each other over the whole surface in the radial and axial directions, as shown in FIG. 13.

### [1-3 Joining]

The radially inner end portions 111 of the outer connection coils 41 and the step portions 26a of the radially outer slot coils 26 which are brought into abutment with each other, the radially inner end portions 122 of the inner connection coils 42 and the step portions 27a of the radially inner slot coils 27 which are brought into abutment with each other, and the outer connection coil extending portions 113 of the outer connection coils 41 and the inner connection coil extending portions 124 of the inner connection coils 42 which are brought into abutment with each other are joined together on planar plate surfaces thereof that intersect a thickness direction through welding, preferably through laser welding. In the following description, joining will be described as being carried out using laser welding.

As shown in FIG. 13, in the outer connection coil extending portions 113 and the inner connection coil extending portions 124, the side surfaces 113a of the outer connection coil extending portions 113 that are oriented in the one circumferential direction and the side surfaces 124a of the inner connection coil extending portions 124 that are oriented in the other circumferential direction are made to face each other for abutment, both of which are planar plate surfaces that intersect the thickness direction and which follow the axial direction, whereby the plate surfaces are brought into surface contact with each other over the whole surface in the radial and axial directions. With both the side surfaces 113a, 124a brought into surface contact with each other, laser welding is executed along abutment planes P1 that extend in the radial direction from axially outer sides of the outer circumferential holes 34 whereby the side surfaces 113a, 124a are joined together on the abutment planes Pl. By adopting this configuration, the radially outer end portions 112 of the outer connection coils 41 and the radially outer end portions 123 of the inner connection coils 42 which are situated in the same outer circumferential holes 34 are electrically connected together, whereby the base plate assemblies 30L, 30R are made up. In FIG. 13, the base plates 31L, 31R are omitted. This will also be true in FIG. 14 which will be described below.

### [1-4 Assemblage]

As shown in FIG. 14, in assembling together the stator core assembly 20 and the base plate assemblies 30L, 30R, the base plates 30L, 30R are assembled to the stator core assembly 20 in the axial direction with the insulation sheets 65 interposed therebetween while aligning the base plate assemblies 30L, 30R relatively with the stator core assembly 20 in the circumferential direction, whereby the radially inner end portions 111 of the outer connection coils 41 are brought into abutment with the step portions 26a of the radially outer slot coils 26 and the radially inner end portions 122 of the inner connection coils 42 are brought into abutment with the step portions 27a of the radially inner slot coils 27, whereby the stator core assembly 20 and the base plate assemblies 30L, 30R are positioned.

In the radially inner end portion 111 of the outer connection coil 41 that is brought into abutment with the step portion 26a of the radially outer slot coil 26, a side surface 111a that is a planar flat surface and which is oriented in the other circumferential direction is brought into abutment with the side surface 26b of the step portion 26a over the whole surface, and the bottom surface 111b is brought into abutment with the bottom surface 26c of the step portion 26a over the whole surface. With both the planar side surfaces 111a, 26b that intersect the thickness direction and which follow in the axial direction brought into surface contact with each other, laser welding is executed along abutment planes P2 that extend in the radial direction from axially outer sides of the radially outer through holes 32, whereby the side surfaces 111a, 26b are joined together on the abutment planes P2.

In the radially inner end portion 122 of the inner connection coil 42 that is brought into abutment with the step portion 27a of the radially inner slot coil 27, a side surface 122a that is a planar flat surface and which is oriented in the one circumferential direction is brought into abutment with the side surface 27b of the step portion 27a over the whole surface, and a bottom surface 122b is brought into abutment with the bottom surface 27c of the step portion 27a over the whole surface. With both the planar side surfaces 122a, 27b that intersect the thickness direction and which follow in the axial direction brought into surface contact with each other, laser welding is executed along abutment planes P3 that extend in the radial direction from axially outer sides of the radially inner through holes 33, whereby the side surfaces 122a, 27b are joined together on the abutment planes P3.

Similarly, the step portions 26a of the radially outer slot coils 26 that are disposed in the radially outer through holes 32a where the busbar notched portions formed and the busbar connecting portions of the busbars 61U, 61V, 61W that are disposed in the busbar notched portions are laser welded together, and the step portions 27a of the radially inner slot coils 27 that are disposed in the radially inner through holes 33a where the middle point busbar notched portions are formed and the middle point busbar connecting portions of the middle point busbars 62 are laser welded together, whereby the busbars 61U, 61V, 61W and the middle point busbars 62 are joined individually to the radially outer slot coils 26 and the radially inner slot coils 27.

The radially outer through holes 32, 32a, the radially inner through holes 33, 33a and the outer circumferential holes 34 exhibit a rectangular shape as seen from the axial direction and have a space greater than the coil members (the radially outer slot coils 26, the radially inner slot coils 27, the outer connection coils 41, the busbar connecting portions, the middle point busbar connecting portions) that are disposed in the interiors thereof, that is, gaps are provided between the laser beam shining portions and the base plates 31L, 31R, and therefore, the base plates 31L, 31R can be prevented from being damaged by the laser beam.

By joining the constituent members together in the way described above, the base plate assemblies 30L, 30R are assembled to the stator core assembly 20 in such a state that the radially outer slot coils 26 and the radially inner slot coils 27 which are inserted into the slots 23 of the stator core 21 are electrically connected together via the outer connection coils 41 and the inner connection coils 42. The outer connection coils 41 and the inner connection coils 42 make up bridge portions of the coil 50 which connect the slot coils 25 of the same phase (for example, the U phase) together.

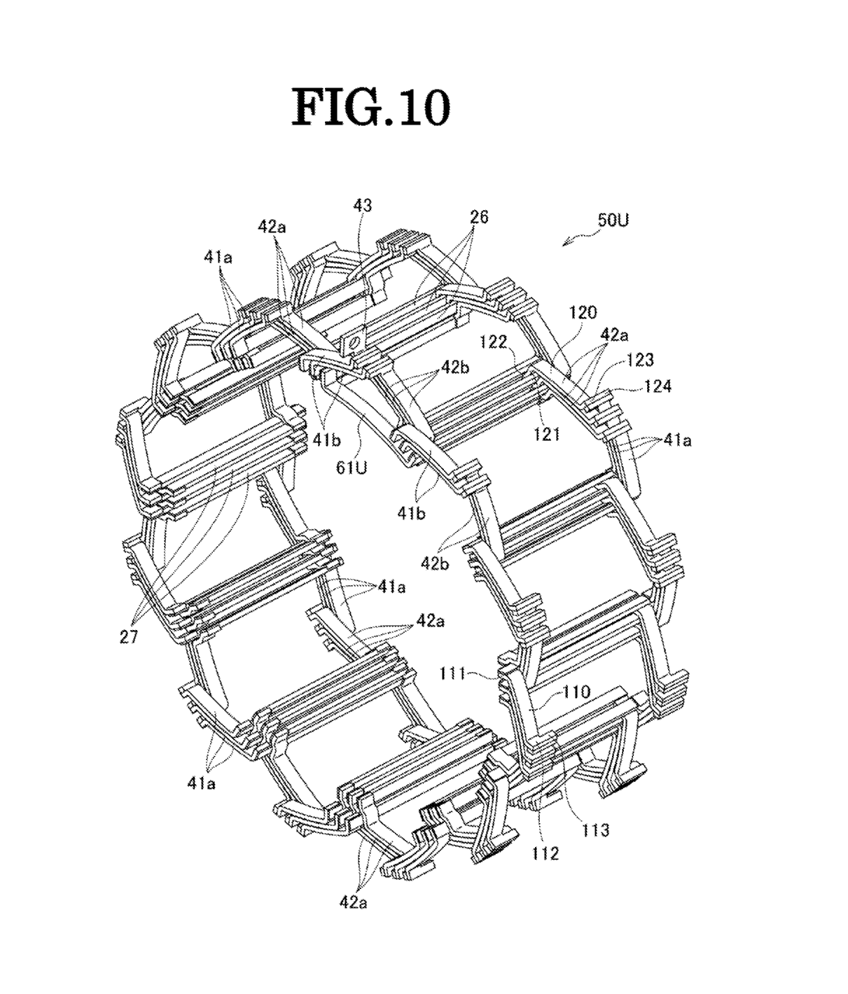

Consequently, for example, as shown in FIG. 10, in relation to the radially outer slot coil 26 and the radially inner slot coil 27 which are disposed in the same slot 23, the outer connection coil 41 that is connected at one end (a near end in the figure) of the radially outer slot coil 26 extends radially outwards and clockwise to be connected to the inner connection coil 42 of the same phase, while the outer connection coil 41 that is connected at the other end (a far end in the figure) of the radially outer slot coil 26 extends radially outwards and counterclockwise to be connected to the inner connection coil 42 of the same phase. In addition, the inner connection coil 42 that is connected at one end (a near end in the figure) of the radially inner slot coil 27 extends radially outwards and counterclockwise to be connected to the outer connection coil 41 of the same phase, while the inner connection coil 42 that is connected to the other end (a far end in the figure) of the radially inner slot coil 27 extends radially outwards and clockwise to be connected to the outer connection coil 41 of the same phase.

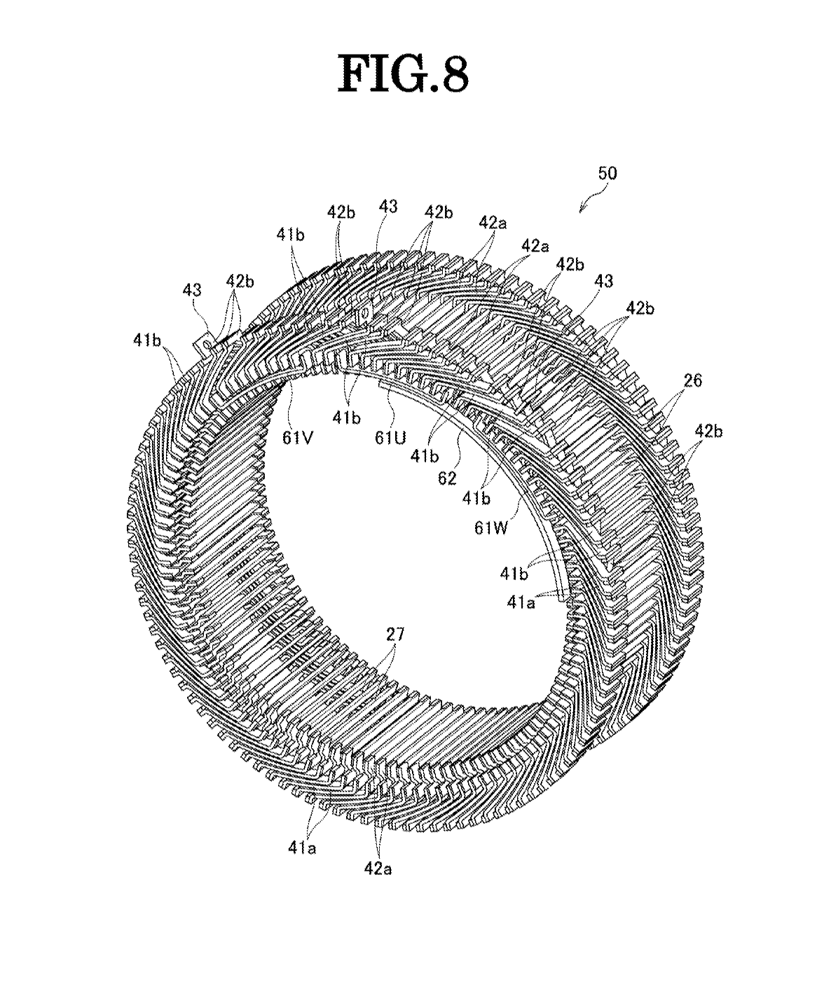

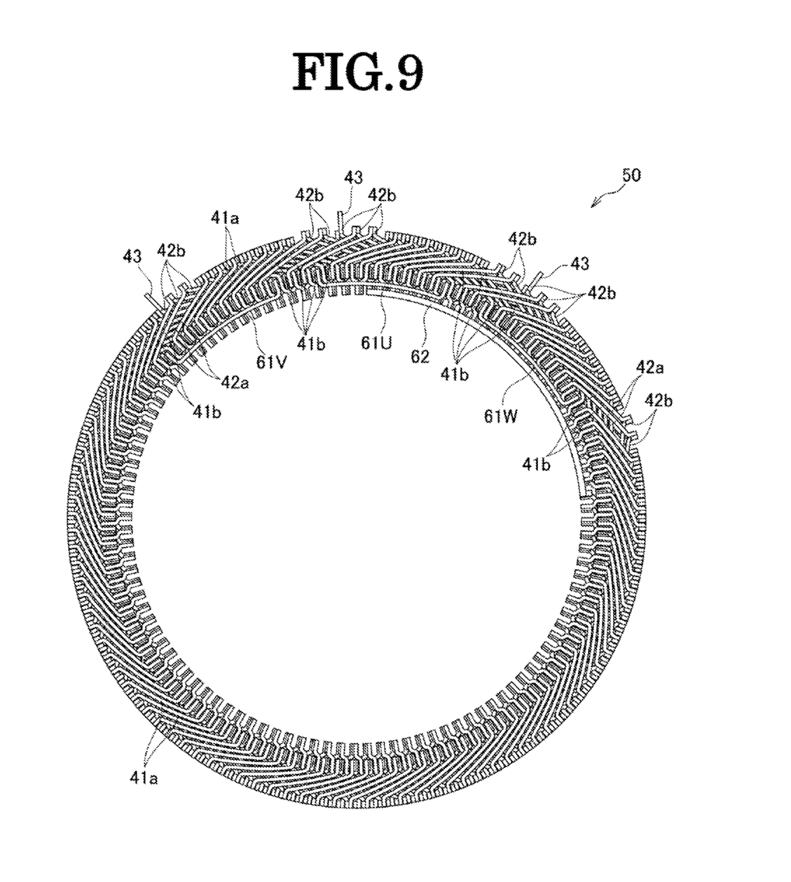

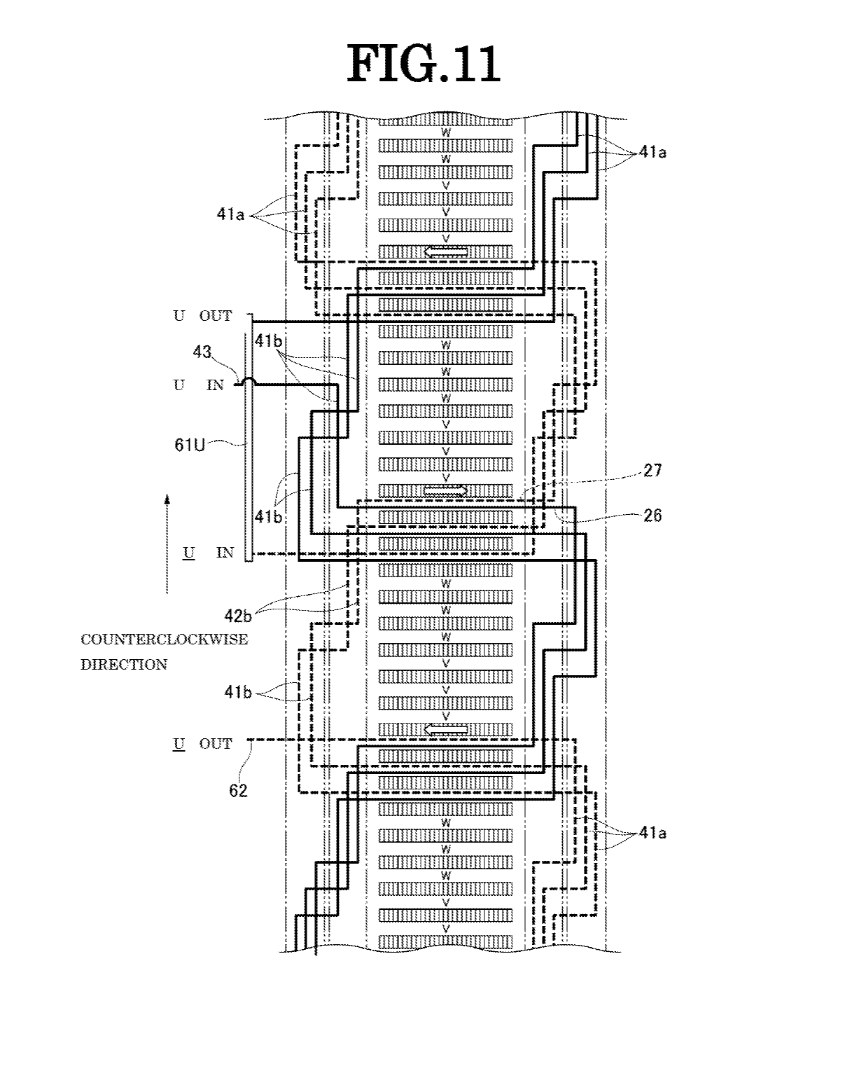

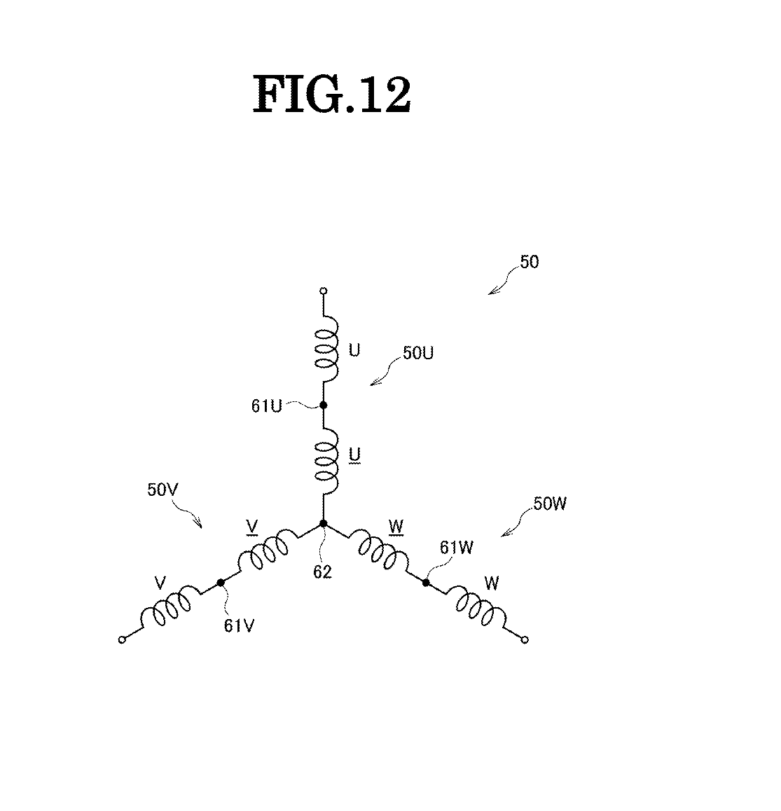

In this way, the stator 10 is made up by assembling the pair of base plate assemblies 30L, 30R to both the ends of the stator core assembly 20, whereby the segmented coil 50 forms six coil loops (U-phase coil 50U, V-phase coil 50V, W-phase coil 50W) having the same construction for each phase. In the six coil loops (U-phase coil 50U, V-phase coil 50V, W-phase coil 50W) for each phase, three sets of U-phase coils 50U, three sets of V-phase coils 50V, and three sets of W-phase coils 50W, each set being made up of two coil loops, are wound counterclockwise in this order through wave winding (refer to FIG. 11). The radially outer slot coil 26 and the radially inner slot coil 27 that are covered with the insulation material 28 and which are disposed in one slot 23 are made by two coil loops that make up one set of coils. FIG. 8 is a perspective view of the coils of the different phases showing the segmented coils of the plurality of phases (U, V, W phases) which are taken out of the stator 10 for the purpose of easy understanding, FIG. 9 is a front view of the FIG. 8, FIG. 10 is a perspective view of the coils of one phase (for example, U phase) Which are further taken out of the coils of the plurality of phases, FIG. 11 is a development view showing a mode of connecting the U-phase coils, and FIG. 12 is a schematic diagram showing a mode of connecting the U-phase, V-phase and W-phase coils together.

A mode of connecting the coils of each phase or U phase, for example, will be described in greater detail by reference to FIG. 11. In the six coil loops that make up the U-phase coil, three coil loops (U loops) are continuously wound clockwise through wave winding, while three coil loops (U loops) are continuously wound counterclockwise through wave winding, and the U loops and the U loops are connected in series by the busbar 61U. The radially outer slot coil 26 and the radially inner slot coil 27 that are covered with the insulation material 28 and which are disposed in one slot 23 are made up of the coil that make up the U loop and the coil that make up the U loop, and an electric current flows in the same direction.

For example, when paying attention to one of the U loops, as shown in FIG. 11, the coil is connected from an axial end (a right-hand side in the figure) of the radially outer slot coil 26 that is disposed in the U-phase slot 23, and then connected through the outer connection coil 41 and the inner connection coil 42 in this order to the radially inner slot coil 27 in the next U-phase slot 23. Thereafter, the coil is connected from the other axial end (a left-hand side in the figure) of the radially inner slot coil 27, and then connected through the inner connection coil 42 and the outer connection coil 41 in this order to the radially outer slot coil 26 in the following U-phase slot 23. From this on, this connecting configuration is repeated to form the U loop.

Similarly, in six loops that make up one of the coils of the remaining another two phases, that is, the V-phase coil (the W-phase coil), too, three V loops (W loops) and three V loops (W loops) that are wound through wave winding in opposite directions are connected in series by the busbar 61V (the busbar 61W), and the radially outer slot coil 26 and the radially inner slot coil 27 that are disposed in one slot 23 are made up of the coil that make up the V loop (W loop) and the coil that make up of the V loop (W loop), and an electric current flows in the same direction. The U-phase coil 50U, the V-phase coil 50V and the W-phase coil 50W are star connected at the middle point busbar 62 as shown in FIG. 12.

In the stator 10, the outer connection coil 41 and the inner connection coil 42 are disposed within an area produced by projecting the stator core 21 in the axial direction and are disposed in different positions in relation to the axial direction. In addition, outer surfaces of the plurality of outer connection coils 41a, 41b that are disposed axially outwards of the stator 10 flush with the end faces of the base plates 31L, 31R.

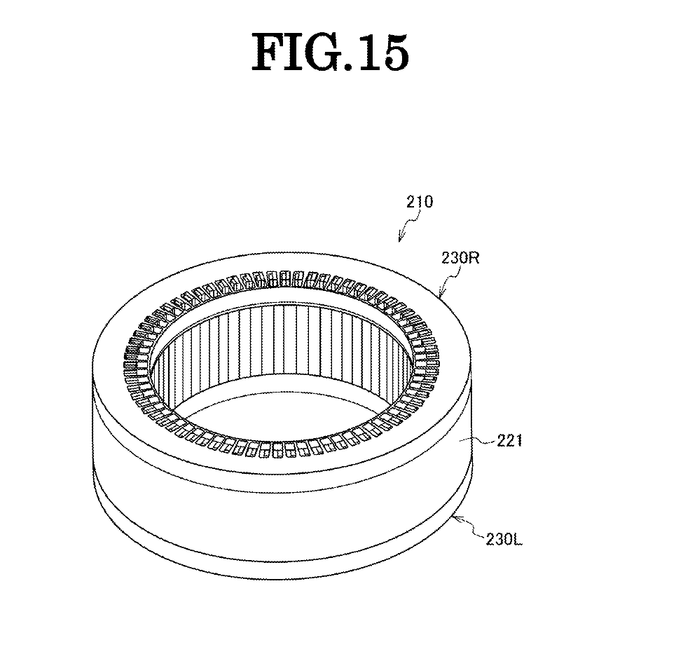

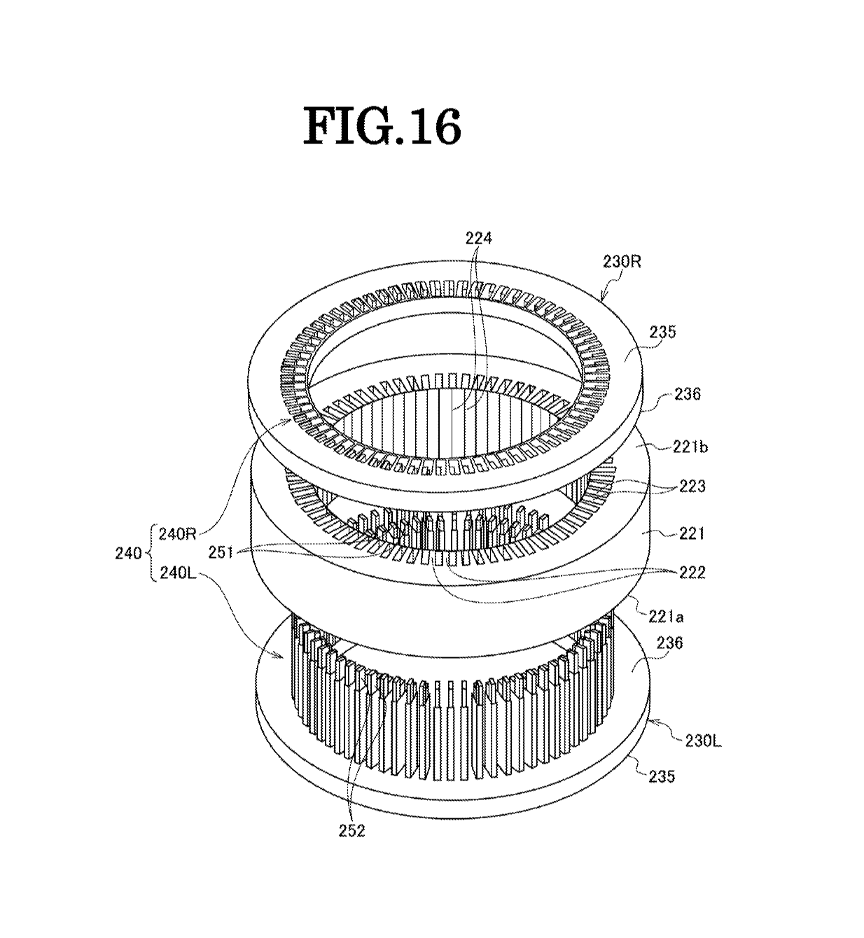

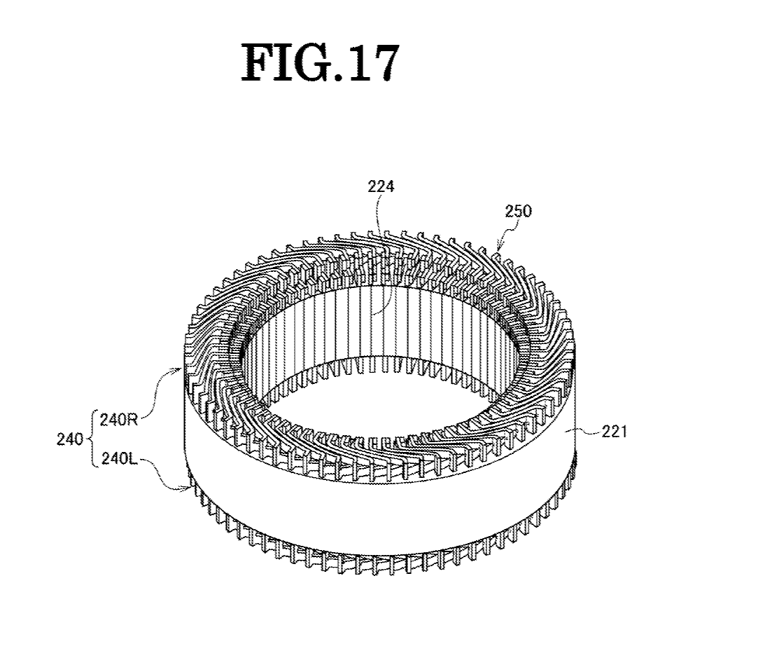

Next, a stator 210 for an electric rotary machine of an embodiment of the invention will be described based on FIGS. 15 to 21B while referring to the stator 10 for the electric rotary machine of the reference example that has been described heretofore.

The stator 210 for an electric rotary machine of this embodiment represents an embodiment that describes the gist of the invention and differs in configuration from the stator 10 for an electric rotary machine of the reference example. For example, in the stator 10 for the electric rotary machine of the reference example, both of the end portions of the radially outer slot coils 26 are connected to the outer connection coils 41, and both of the end portions of the radially inner slot coils 27 are connected to the inner connection coils 42. However, in the stator 210 for the electric rotary machine of this embodiment, which will be described below, the one end portions of the radially outer slot coils 26 are connected to the outer connection coils 41 while the other end portions thereof are connected to the inner connection coils 42, and one end portions of the radially inner slot coils 27 are connected to the inner connection coils 42 while the other end portions thereof are connected to the outer connection coils 41. In addition, the stator 210 differs from the stator 10 in the number of slots (the number of coils) in the stator core.

Additionally, in the following description, detailed configurations such as the busbars 61U, 61V, 61W, the middle point busbars 62, the difference between the outer connection coils 41a, 41b, the difference between the inner connection coils 42a, 42b, and a connection mode of coils 250 described in the stator 10 for the electric rotary machine of the reference example will be omitted.

The stator 210 for an electric rotary machine of the invention substantially differs from the stator 10 for an electric rotary machine of the reference example in that connection coils 240 that correspond to the outer connection coils 41 and the inner connection coils 42 are made up of integral conductors.

In addition, in the embodiment which will be described below, in a first connection coil 240L of the connection coil 240 (the first connection coil 240L and a second connection coil 240R), a member that corresponds to the slot coil 25 in the stator 10 for an electric rotary machine of the reference example is also made up of an integral conductor. Additionally, the first connection coils 240L are formed integrally through molding into a first molded body 230L with members that correspond to the base plate 31L and the insulation material 28 of the reference example. The second connection coils are formed integrally through molding into a second molded body 230R with a member that corresponds to the base plate 31R of the stator 10 for an electric rotary machine of the reference example. However, these configurations are not essential configurations of the invention and hence can be modified as required.

### [2 Stator]

As shown in FIGS. 15 to 17, the stator 210 for an electric rotary machine of this embodiment includes a stator core 221 and the pair of first and second molded bodies 230L, 230R, and the first and second molded bodies 230L, 230R are disposed and assembled to both ends of the stator core 21.

### [2-1 Stator Core]

The stator core 221 is made up, for example, of plural pressed sheets of silicon steel that are laminated together and includes plural teeth 222 and plural slots 223 that are defined between the adjacent teeth 222 on a radially inner side thereof. The slots 223 are formed so as to penetrate the stator core 221 in an axial direction thereof, are each formed into a substantially elliptic shape that is long in a radial direction of the stator core 221 as seen in the axial direction and each has an opening portion 224 that opens to an inner circumferential surface of the stator core 221.

### [2-2 Connection Coils]

The connection coil 240 is formed of a conductive material such as copper into a plate shape and is made up of the first connection coil 240L that is molded into the first molded body 230L and which is disposed further axially outwards than one end face 221a of the stator core 221 and the second connection coil 240R that is molded into the second molded body 230R and which is disposed further axially outwards than the other end face 221b of the stator core 221.

### [2-2-1 First Connection Coil]

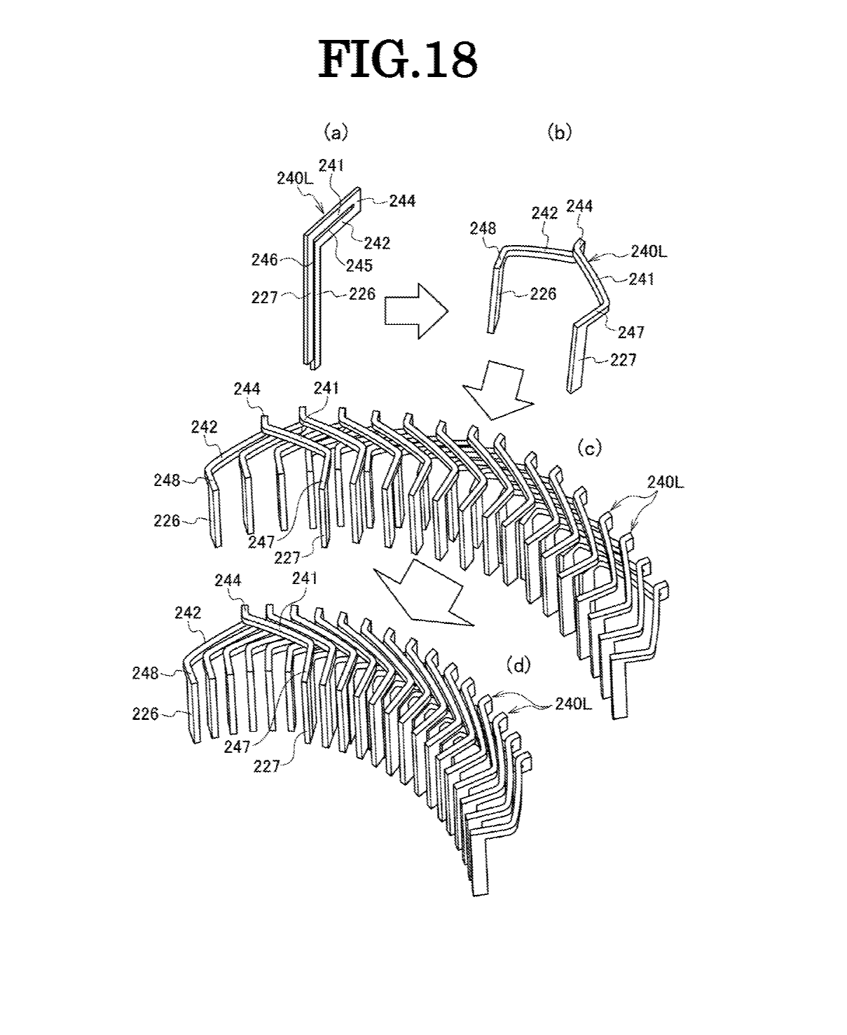

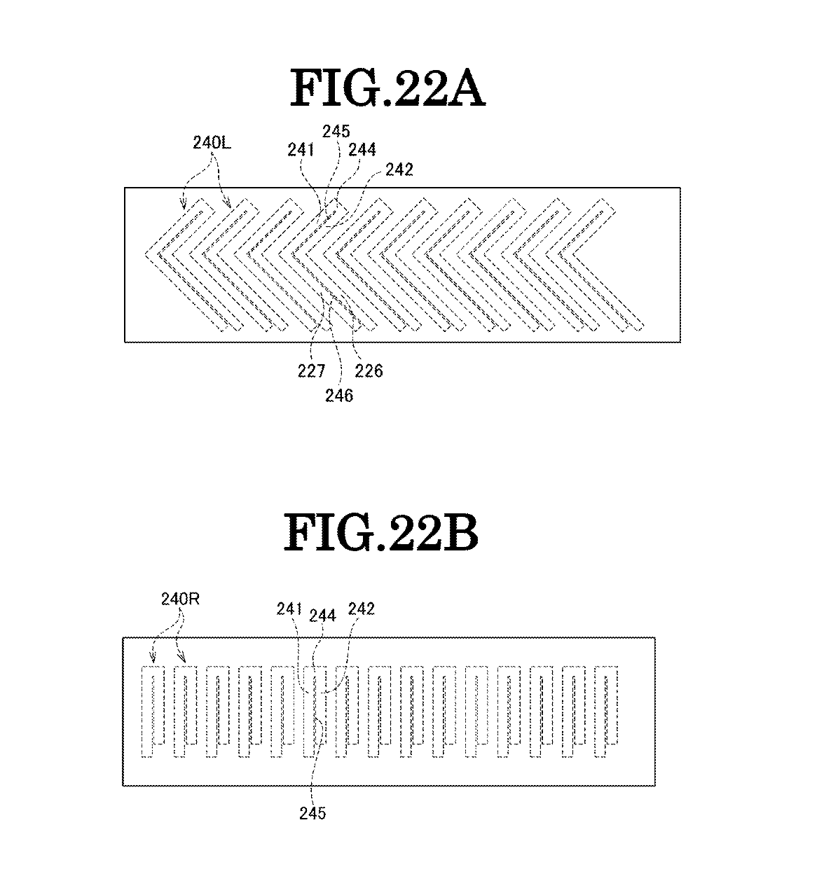

As shown in FIG. 18(a), the first connection coil 240L is made up of one plate conductor. An outer connection coil portion 241 and a radially inner slot coil portion 227 that are formed substantially into an L shape and which correspond to the outer connection coil 41 and the radially inner slot coil 27 of the stator 10 for an electric rotary machine of the reference example, and an inner connection coil portion 242 and a radially inner slot coil portion 226 that are formed substantially into an L shape and which correspond to the inner connection coil 42 and the radially outer slot coil 26 of the stator 10 for an electric rotary machine of the reference example are connected together at an axial extending portion 244 that extends parallel to the radially outer slot coil portion 226 and the radially inner slot coil portion 227 at one end portions of the outer connection coil portion 241 and the inner connection coil portion 242 which lie opposite to the radially outer slot coil portion 226 and the radially inner slot coil portion 227. The first connection coil 240L has a plate body as a result of the outer connection coil portion 241 being formed so as to project longer by a length that is substantially equal to a width (a radial width) of the radially outer slot coil portion 226 than the inner connection coil portion 242. Consequently, the first connection coil 240L can be formed of a flat plate material like one shown in FIG. 22A through press (stamping) forming.

Before bent forming, the outer connection coil portion 241 and the inner connection coil portion 242 lie opposite to each other across a first slit 245, and the radially inner slot coil portion 227 and the radially outer slot coil portion 225 lie opposite to each other across a second slit 246 that continues from the first slit 245 and which intersects the first slit 245 at right angles. The radially outer slot coil portion 226 is formed so as to project longer by a length that is substantially equal to an axial width of the outer connection coil portion 241 than the radially inner slot coil portion 227 at a distal end portion thereof. The radially outer slot coil portion 226 is connected to the outer connection coil portion 241 of the second molded body 230R, which will be described later, and the radially inner slot coil portion 227 is connected to the inner connection coil 242 of the second molded body 230R.

In the first connection coil 240L that is formed in the way described above, as shown in FIG. 18(b), the outer connection coil portion 241 and the inner connection coil portion 242 are bent relative to the axial extending portion 244, and further, radially inner end portions 247, 248 of the outer connection coil portion 241 and the inner connection coil portion 242 are bent, whereby When seen from the axial direction, the outer connection coil portion 241 and the inner connection coil portion 242 extend in different circumferential directions relative to the axial extending portion 244, the radially inner end portions 247, 248 extend radially inwards while being oriented towards an axis or center of the stator core 221, and the radially inner slot coil portion 227 and the radially outer slot coil portion 226 extend in the axial direction. The outer connection coil portion 241 and the inner connection coil portion 242 are disposed on planes that intersect the axial direction at right angles and which lie in different axial positions. The radially outer slot coil portion 226 is situated further radially outwards than the radially inner slot coil portion 227.

In the first connection coil 240L, the outer connection coil 41, the inner connection coil 42, the radially outer slot coil 26 and the radially inner slot coil 27 of the stator 10 for an electric rotary machine of the reference example are formed of the single plate conductor, and these constituent parts are fabricated through press forming and bend forming, for example. Consequently, at the one end of the stator core 21 in the stator 10 for an electric rotary machine of the reference example, the joining of the radially inner end portion 111 of the outer connection coil 41 and the step portion 26a of the radially outer slot coil 26, the joining of the radially inner end portion 122 of the inner connection coil 42 and the step portion 27a of the radially inner slot coil 27, and the joining of the outer connection coil extending portion 113 of the outer connection coil 41 and the inner connection coil extending portion 124 of the inner connection coil become unnecessary.

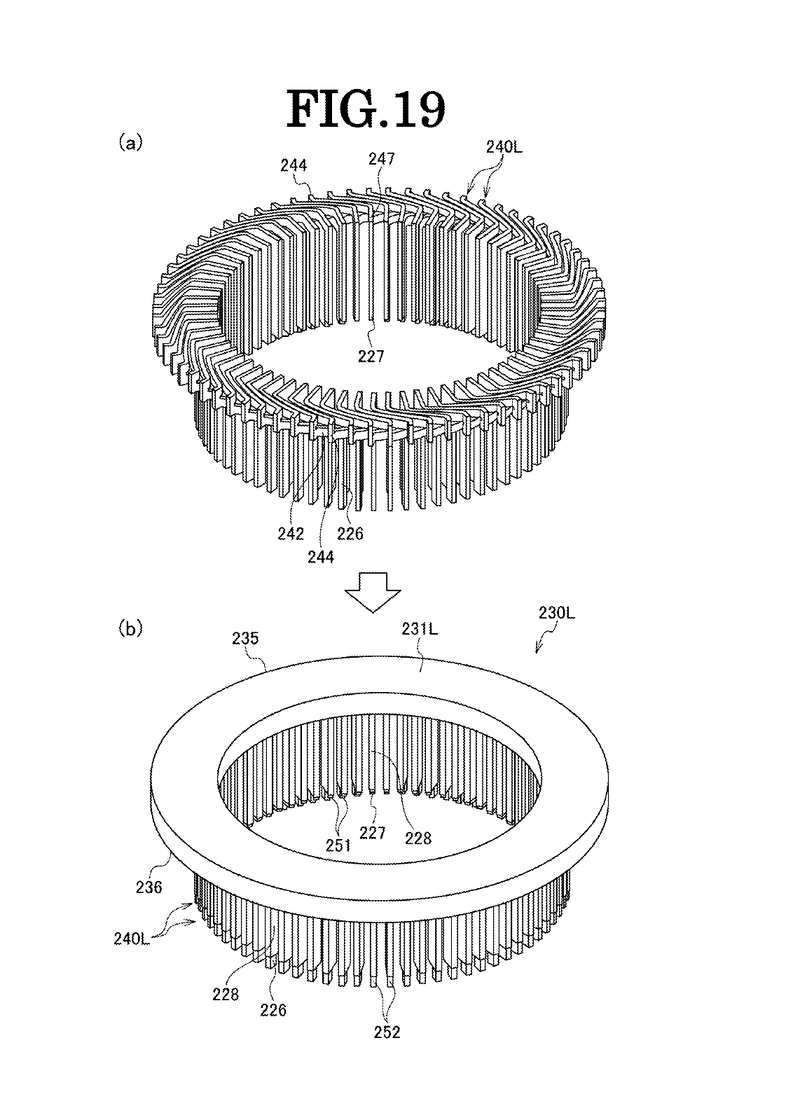

The first connection coils 240L that are formed into a predetermined shape through bend forming are aligned in the circumferential direction as shown in FIG. 18(c), and by adjusting spaces between the adjacent first connection coils 240L as shown in FIG. 18(d), the first connection coils 240L are aligned at uniform intervals in the circumferential direction as shown in FIG. 19(a).

### [2-2-2 Second Connection Coil]

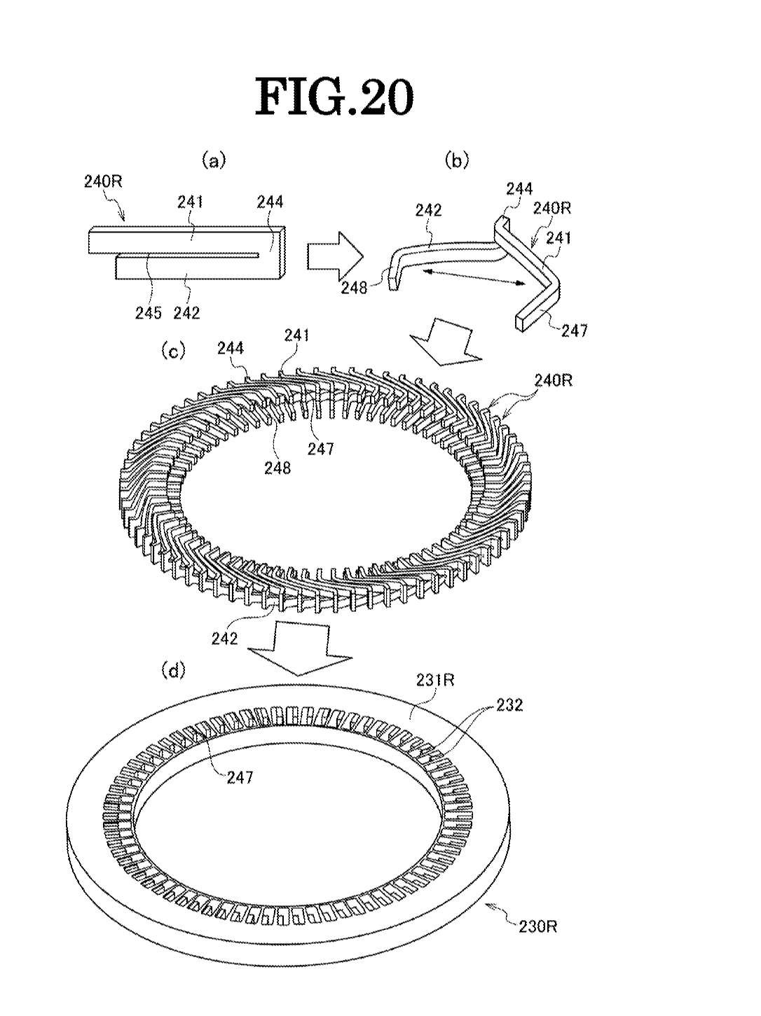

As shown in FIG. 20(a), the second connection coil 240R is made up of one plate conductor. An outer connection coil portion 241 that extends in a straight line and which corresponds to the outer connection coil 41 of the stator 10 for an electric rotary machine of the reference example and a inner connection coil portion 242 that extends in a straight line and parallel to the outer connection coil portion 241 and which corresponds to the inner connection coil 42 of the stator 10 for an electric rotary machine are connected together at one end portions of the outer connection coil portion 241 and the inner connection coil portion 242 by an axial extending portion 244 that extends in a direction that intersects the outer connection coil portion 241 and the inner connection coil portion 242 at right angles. The outer connection coil portion 241 is formed so as to project longer by a length that is substantially equal to the width (the radial width) of the radially outer slot coil portion 226 than the inner connection coil portion 242. This second connection coil 240R can be formed of a flat plate material like one shown in FIG. 22B through press (stamp) forming.

Before bent forming, the outer connection coil portion 241 and the inner connection coil portion 242 lie opposite to each other across a first slit 245.

In the second connection coil 240R that is formed in the way described above, as shown in FIG. 20(b), the outer connection coil portion 241 and the inner connection coil portion 242 are bent relative to the axial extending portion 214, and further, radially inner end portions 247, 248 of the outer connection coil portion 241 and the inner connection coil portion 242 are bent, whereby when seen from the axial direction, the outer connection coil portion 241 and the inner connection coil portion 242 extend in different circumferential directions relative to the axial extending portion 244, and the radially inner end portions 247, 248 extend radially inwards while being oriented towards the axis or center of the stator core 221. The outer connection coil portion 241 and the inner connection coil portion 242 are disposed on planes that intersect the axial direction at right angles and which lie in different axial positions.

In the second connection coil 240R, the outer connection coil 41 and the inner connection coil 42 of the stator 10 for an electric rotary machine of the reference example are formed of the single plate conductor, and these constituent parts are fabricated through press forming and bend forming, for example. Consequently, the joining of the outer connection coil extending portion 113 of the outer connection coil 41 and the inner connection coil extending portion 124 of the inner connection coil 42 that is executed in the stator 10 for an electric rotary machine of the reference example becomes unnecessary.

The second connection coils 240R that are formed into a predetermined shape through bend forming are aligned in the circumferential direction and by adjusting spaces between the adjacent second connection coils 240R as shown in FIG. 20(c), the second connection coils 240R are aligned at uniform intervals in the circumferential direction.

### [2-3 First Molded Body]

The plurality of first connection coils 240L that are aligned at uniform intervals in the circumferential direction as shown in FIG. 19(a) makes up the first molded body 230L as a result of a base plate portion 231L and slot insulating portions 228 that correspond to the base plate 31L and the insulation materials 28 of the stator 10 for an electric rotary machine of the reference example being formed integrally with the first connection coils 240L through resin molding as shown in FIG. 19(b). An outer surface 235 and an inner surface 236 of the base plate portion 231L are made into a flat plane that is covered by a molded resin and which has no holes formed therein because they do not have to be joined as described above, and the radially inner slot coil portions 227 and the radially outer slot coil portions 226 that are covered with the slot insulating, portions 228 project in the axial direction from the inner surface 236. Only distal end portions 251, 252 of the radially inner slot coil portions 227 and the radially outer slot coil portions 226 are not covered with the slot insulating portions 228.

In addition, the base plate portion 231L has a partition wall portion (not shown) situated between the inner connection coil portions 242 and the outer connection coil portions 241 that are spaced apart in the axial direction and wall portions (not shown) situated between the adjacent inner connection coil portions 242 and the adjacent outer connection coil portions 241 which correspond to the wall portions 31b and the partition wall 31c of the stator 10 for an electric rotary machine of the reference example, and therefore, the base plate portion 231L ensures the insulation between the inner connection coil portions 242 and the outer connection coil portions 241 and the insulation between the adjacent inner connection coil portions 242, and the insulation between the adjacent outer connection coil portions 241.

### [2-4 Second Molded Body]

The plurality of second connection coils 240R that are aligned at uniform intervals in the circumferential direction as shown in FIG. 20(e) makes up the second molded body 230R as a result of a base plate portion 231R that corresponds to the base plate 31R of the stator 10 for an electric rotary machine of the reference example being formed integrally with the second connection coils 240R through resin molding as shown in FIG. 20(d). A plurality of through holes 232 are provided in an outer surface 235 and an inner surface 236 of the base plate portion 231R in positions that correspond to the radially inner end portions 247, 248 of the outer connection coil portions 241 and the inner connection coil portions 242, and the other areas than the through holes 232 are covered by a molded resin to represent a flat surface.

In addition, like the base plate portion 231L, the base plate portion 231R also has a partition wall portion (not shown) situated between the inner connection coil portions 242 and the outer connection coil portions 241 that are spaced apart in the axial direction and wall portions (not shown) situated between the adjacent inner connection coil portions 242 and the adjacent outer connection coil portions 241 which correspond to the wall portions 31b and the partition wall 31c of the stator 10 for an electric rotary machine of the reference example, and therefore, the base plate portion 231R ensures the insulation between the inner connection coil portions 242 and the outer connection coil portions 241, the insulation between die adjacent inner connection coil portions 242, and the insulation between the adjacent outer connection coil portions 241.

### [2-5 Assemblage]

In assembling the stator core 221 and the first and second molded bodies 230L, 230R, firstly, the stator core 221 and the first molded body 230L are assembled together in the axial direction by aligning the stator core 221 relatively with the first molded body 230L in the circumferential direction, whereby the radially inner slot coil portions 227 and the radially outer slot coil portions 226 that are surrounded around their outer circumferences by the slot insulating portions 228 are disposed individually in slots 223. Then, one end face 221a of the stator core 221 is brought into abutment with the inner surface 236 of the first molded body 230L, and distal end portions 251, 252 of the radially inner slot coil portions 227 and the radially outer slot coil portions 226 project from the other end face 221b of the stator core 221.

Following this, the stator core 221 to which the first molded body 230L has been assembled is aligned relatively with the second molded body 230R in the circumferential direction for assemblage, whereby the other end face 221b of the stator core 221 is brought into abutment with the inner surface 236 of the second molded body 230R, and the distal end portions 251, 252 of the radially inner slot coil portions 227 and the radially outer slot coil portions 226 are disposed individually in the plurality of through holes 232 that penetrate the base plate portion 231R of the second molded body 230R.

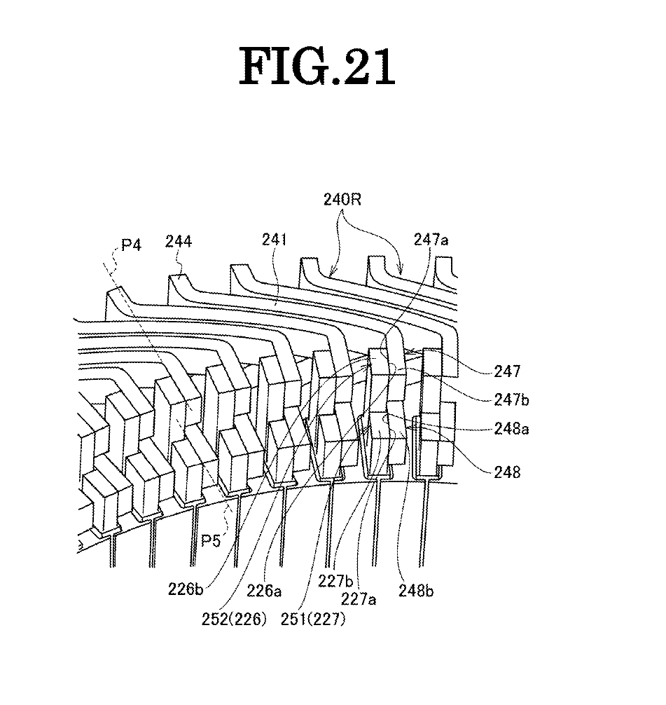

The radially inner slot coil portions 227 and the radially outer slot coil portions 226 that are disposed individually in the through holes 232 are brought into abutment with the radially inner end portions 247, 248 of the outer connection coil portions 241 and the inner connection coil portions 242 of the second molded body 230R that are also disposed individually in the through holes 232. To describe this more specifically, as shown in FIG. 21, plate surfaces 226a of the distal end portions 252 of the radially outer slot coil portions 226 which are oriented in one circumferential direction are brought into abutment with plate surfaces 247a of the radially inner end portions 247 of the outer connection coil portions 241 which are oriented in the other circumferential direction, and axial end faces 226b of the radially outer slot coil portions 226 flush with axial end faces 247b of the outer connection coil portions 241. In addition, plate surfaces 227a of the radially inner slot coil portions 227 which are oriented in the one circumferential direction are brought into abutment with plate surfaces 248a of the radially inner end portions 248 of the inner connection coil portions 242 which are oriented in the other circumferential direction, and axial end faces 227b of the radially inner slot coil portions 227 flush with axial end faces 248b of the inner connection coil portions 242.

With the abutted plate surfaces 226a, 247a kept in surface contact with each other and the abutted plate surfaces 227a, 248a also kept in surface contact with each other, laser welding is executed along abutment planes P4, P5 that extend in a radial direction from an axially outer side of the through holes 232, whereby the radially outer slot coil portions 226 and the outer connection coil portions 241 of the second molded body 230R are joined together on the abutment plane P4, and the radially inner slot coil portions 227 and the inner connection coil portions 242 of the second molded body 230R are joined together on the abutment plane P5. The abutment planes P4, P5 may be situated on the same straight line or different straight lines.

By joining the constituent parts together in the way described above, the radially outer slot coil portions 226 and the radially inner slot coil portions 227 are connected electrically via the outer connection coil portions 241 and the inner connection connection coil portions 242, the coil 250 is made up of the first connection coils 240L and the second connection coils 240R, and the stator core 221 and the first and second molded bodies 230L, 230R are assembled together.

Thus, as has been described heretofore, according to the stator 210 for an electric rotary machine of this embodiment, in the connection coil 240 (the first connection coil 240L, the second connection coil 240R), since the inner connection coil portion 242, the outer connection coil portion 241 and the axial extending portion 244 are made up of the integral conductor, the connection coil 40 of the stator 10 for an electric rotary machine of the reference example that is made up of the two parts of the outer connection coil 41 and the inner connection coil 42 can be made up of the one part. Consequently, compared with the connection coil 40, not only can the number of parts involved be reduced, but also the joining step can be eliminated of joining the outer connection coil extending portion 113 of the outer connection coil 41 and the inner connection coil extending portion 124 of the inner connection coil 42 together.

In addition, in the connection coil 240 (the first connection coil 240L, the second connection coil 240R) since the inner connection coil portion 242, the outer connection coil portion 241 and the axial extending portion 244 are made up of the integral plate conductor, the connection coil 240 can be formed of the integral plate conductor through press forming, for example, and the inner connection coil portion 242 and the outer connection coil portion 241 can be formed into the desired shape through bend forming. Thus, the radially inner slot coil portion 227 and the radially outer slot coil portion 226 of the first connection coil 240L can easily be disposed in the slots 223 that are situated in the different circumferential positions while forming the connection coil 40 of the stator 10 for an electric rotary machine of the reference example by the one part. Additionally, the second connection coil 240R can easily be formed into the shape for connecting together the radially inner slot coil portion 227 and the radially outer slot coil portion 226 which are disposed in the slots 223 situated in the different circumferential positions.

In the first connection coil 240L, since the radially outer slot coil portion 226 and the radially inner slot coil portion 227 are further connected to the inner connection coil portion 242 and the outer connection coil portion 241 as the integral conductor, the outer connection coil 41, the inner connection coil 42, the radially outer slot coil 26 and the radially inner slot coil 27 of the stator 10 for an electric rotary machine of the reference example can be made up of the one part, not only the number of parts that make up the coil be reduced, but also the joining step of joining the radially inner end portion 111 of the outer connection coil 41 and the step portion 26a of the radially outer slot coil 26 and the joining step of joining the radially inner end portion 122 of the inner connection coil 42 and the step portion 27a of the radially inner slot coil 27 which are executed at the one end of the stator core 21 of the stator 10 for an electric rotary machine of the reference example can be eliminated.

In addition, in the first and second molded bodies 230L, 230R, the connection coils 240 (the first connection coils 240L, the second connection coils 240R) are formed integrally with the base plate portions 231L, 231R through molding, and the base plate portions 231L, 231R have the partition wall portions that are situated between the inner connection coil portions 242 and the outer connection coil portions 241 that are spaced apart from each other in the axial direction and the wall portions that are situated between the adjacent outer connection coil portions 241 and between the adjacent inner connection coil portions 242. Therefore, the insulation between the inner connection coil portions 242 and the outer connection coil portions 241, the insulation between the adjacent first connection coils 240L, and the insulation between the adjacent second connection coils 240R can be realized by the base plate portions 231L, 231R.

Additionally, according to this embodiment, the insulation sheets 65 that are disposed between the stator core 21 and the base plate assemblies 30L, 30R in the stator 10 for an electric rotary machine of the reference example become unnecessary.

Since the base plate portion 231L and the slot insulating portions 228 that cover the outer circumferences of the radially inner slot coil portions 227 and the radially outer slot coil portions 226 are formed integrally with the first molded body 230L, the insulation between the radially inner slot coil portions 227 and the radially outer slot coil portions 226 and the stator core 221 can also be realized by the slot insulating portions 228 that are formed integrally with the base plate portion 231L.

The invention is not limited to the embodiment which has been described heretofore and hence can be modified or improved as required.

For example, a stator of single slot type in which coils of different phases are disposed individually and sequentially slots that are arranged in the circumferential direction or a stator of double slot type in which coils of the same phase are disposed in every two slots that lie adjacent to each other in the circumferential direction or a stator of triple slot type in which coils of the same phase are disposed in very three slots that lie adjacent to one another in the circumferential direction can be used as required.

In relation to the form of connecting the coils, arbitrary specifications can be selected, and a series connection and a parallel connection can also be selected as required.

This patent application is based on Japanese Patent Application (No. 2014-072868) filed on Mar. 31, 2014, the contents of which are incorporated herein by reference.

### DESCRIPTION OF REFERENCE NUMERALS

210 stator for electric rotary machine
221 stator core
221a, 221b axial end face of stator core
223 slot
226 radially outer slot coil portion
227 radially inner slot coil portion
228 slot insulating portion
231L base plate portion (insulation plate portion, first insulation plate portion)
231R base plate portion (insulation plate portion, second insulation plate portion)
240 connection coil
241 outer connection coil portion
242 inner connection coil portion
244 axial extending portion
250 coil

1. A stator for an electric rotary machine comprising:
a stator core, which has plural slots; and
a coil, which is attached to the stator core, wherein:
the coil has plural slot coils, each slot coil being inserted into the slot, and plural connection coils, each connection coil connecting the slot coils in a position lying further axially outwards than an axial end face of the stator core;
the connection coil has an inner connection coil portion and an outer connection coil portion, the inner connection coil portion and the outer connection coil portion being disposed individually on planes that intersect an axial direction at a right angle and that lie in different axial positions, and an axial extending portion that connects the inner connection coil portion and the outer connection coil portion; and
the inner connection coil portion, the outer connection coil portion, and the axial extending portion are configured by an integral conductor.

2. The stator for an electric rotary machine according to claim 1, wherein:
the inner connection coil portion, the outer connection coil portion, and the axial extending portion are made up of an integral plate conductor; and
when seen from the axial direction, the inner connection coil portion and the outer connection coil portion extend in different directions.

3. The stator for an electric rotary machine according to claim 1,
wherein
a slot coil portion that makes up the slot coil is further connected to at least one of the inner connection coil portion and the outer connection coil portion as the integral conductor.

4. The stator for an electric rotary machine according to claim 1, wherein:
the stator further comprises an insulation plate portion that are molded integrally with the connection coils; and
the insulation plate portion has a partition wall portion, which is situated between the inner connection coil portion and the outer connection coil portion that are spaced away from each other in the axial direction, and a wall portion, which is situated between the connection coils that lie adjacent to each other.

5. The stator for an electric rotary machine according to claim 1, wherein:
the connection coil includes: a first connection coil that connects the plural slot coils together in a position lying further axially outwards than one axial end face of the stator core; and a second connection coil that connects the plural slot coils together in a position lying further axially outwards than an other axial end face of the stator core;
the first connection coil has: a first inner connection coil portion and a first outer connection coil portion, which are disposed individually on planes that intersect the axial direction at a right angle and that lie in different axial positions; and a first axial extending portion, which connects the first inner connection coil portion and the first outer connection coil portion;
the second connection coil has: a second inner connection coil portion and a second outer connection coil portion, which are disposed individually on planes that intersect the axial direction at a right angle and that lie in different axial positions; and a second axial extending portion, which connects the second inner connection coil portion and the second outer connection coil portion;
the first inner connection coil portion, the first outer connection coil portion, and the first axial extending portion are configured by an integral conductor; and
the second inner connection coil portion, the second outer connection coil portion, and the second axial extending portion are configured by an integral conductor.

6. The stator for an electric rotary machine according to claim 5, wherein:
the stator further includes: a first insulation plate portion, which is molded integrally with the first connection coil; and a second insulation plate portion, which is molded integrally with the second connection coil;
the first insulation plate portion includes: a partition wall portion, which is situated between the first inner connection coil portion and the first outer connection coil portion that are spaced away from each other in the axial direction; and a wall portion, which is situated between the first connection coils that lie adjacent to each other;
the second insulation plate portion includes: a partition wall portion, which is situated between the second inner connection coil portion and the second outer connection coil portion that are spaced away from each other in the axial direction; and a wall portion, which is situated between the second connection coils that lie adjacent to each other;
in the first connection coil, a slot coil portion that makes up the slot coil is further connected to at least one of the first inner connection coil portion and the first outer connection coil portion as the integral conductor; and
a slot insulating portion that covers an outer circumference of the slot coil portion is configured integrally with the first insulation plate portion.
